(19) United States
(12) Patent Application Publication
(10) Pub. No.: US 2019/0220498 A1
(43) Pub. Date: Jul. 18, 2019

(54) DIGITAL SIGNAL PROCESSING SYSTEM AND DESIGN METHOD THEREOF

(71) Applicant: Der-Feng Huang, Taoyuan City (TW)

(72) Inventor: Der-Feng Huang, Taoyuan City (TW)

(21) Appl. No.: 15/871,100

(22) Filed: Jan. 15, 2018

(51) Int. Cl. G06F 17/15; G06F 17/14; G06F 17/16

(52) U.S. Cl. CPC G06F 17/15; G06F 17/16; G06F 17/141

(57) ABSTRACT

A digital signal processing system and its design method are disclosed. The digital signal processing system is a digital differentiator with a frequency response coefficient hₘ and a frequency response function H^{(K)}(w), where

$${H}^{( K )} ( w ) is one of \{ \begin{matrix}- {jw}^{K} , 0 \leq w < π \\ {jw}^{K} , - π \leq w \leq 0\end{matrix} , \{ \begin{matrix}{jw}^{K} , 0 \leq w < π \\ - {jw}^{K} , - π \leq w \leq 0\end{matrix} , \\ - {w}^{K} , - π \leq w < π , and \{ \begin{matrix}{jw}^{K} , 0 \leq w < π \\ - {jw}^{K} , - π \leq w \leq 0\end{matrix} ,$$

or combination thereof, where m of hₘ has a range 0≤m≤M−1 and M is the sampling point quantity.

### BACKGROUND OF THE INVENTION

### (a) Technical Field of the Invention

The present invention is generally related to a design method of a digital signal processing system, and more particular to a digital differentiator and its design method.

### (b) Description of the Prior Art

Digital differentiators are commonly applied to various digital signal processing systems, such as digital filter or digital controllers. For many practical applications, the digital differentiators are usually designed in a linear phase form (i.e., linear-phased digital differentiators) characterized by the feature h[n]=−h[M−1−n]. Taking a M=7 digital differentiator as example, its transfer function is H(z)=h(0)+h(1)z⁻¹+h(2)z⁻²+h(3)z⁻³−h(2)z⁻⁴+h(1)z⁻⁵−h(0)z⁻⁶, or H(z)=h(0)[1−z⁻⁶]+h(1)[z⁻¹−z⁻⁵]+h(2)[z⁻²−z⁻⁴]+h(3)z⁻³, and the transfer function block diagram is shown in FIG. 18.

The frequency sampling method of the conventional digital differentiators mainly concerns the sampling point problem, i.e. the sampling frequency wₖ, where

$${w}_{k} = \frac{2 π k}{M} , 0 \leq k \leq M - 1 ,$$

M is the sampling point quantity, and the frequency response function is

$${{H ( k ) = {H}_{d} ( w ) \vert}_{w = {w}_{k}} = {H}_{d} ( w ) \vert}_{w = \frac{2 π}{M}} = {H}_{d} ( {e}^{j \frac{2 π k}{M}} ) .$$

Republic of China, Taiwan, Patent Publication No. TW 201340599 uses Simpson integrator and fractional delay to obtain the transfer function, and then uses the order of the sampling frequency to reduce the error of the Simpson integrator and to enhance the accuracy of the high-order, low frequency filter. It is also convenient to use Fourier transform of Fast Fourier transform (FFT) to design digital signal processing system.

As shown in FIG. 1, the black dots are sample points of Discrete Fourier transform (DFT), where |Hᵣ(w)| is its amplitude response. These black dots are the points to be designed. For digital signal processing systems such as filters, the coefficient h(n) can be obtained by Inverse DFT (TDFT) as

$$h ( n ) = \frac{1}{M} {\sum }_{k = 0}^{M - 1} H ( k ) {e}^{j \frac{2 π nk}{M}} , H ( {e}^{j \frac{2 π nk}{M}} ) = H ( k ) = {H}_{d} ( {e}^{- j \frac{2 π nk}{M}} ) .$$

### When

$${w}_{k} = \frac{2 π k}{M} , H ( {e}^{jw} ) = {H}_{d} ( {e}^{jw} ) ,$$

and at other frequencies, H_{d}(e^{jw}) may be viewed as the interpolated sampling points. As h(n) is obtained through IDFT, and conventional design methods are to obtain the IDFT for H(k), where the matrix form for IDFT[H(K)] is

$$H = \frac{1}{M} {W}^{*} H and$$

$${W}^{*} = [ \begin{matrix}1 & 1 & 1 & … & 1 & 1 & 1 & 1 & … & 1 & 1 \\ 1 & {e}^{j {θ}_{M}} & {e}^{j 2 {θ}_{M}} & ⋱ & {e}^{j ( \frac{M - 1}{2} - 1 ) {θ}_{M}} & {e}^{j ( \frac{M - 1}{2} ) {θ}_{M}} & {e}^{j ( \frac{M - 1}{2} + 1 ) {θ}_{M}} & {e}^{j ( \frac{M - 1}{2} + 2 ) {θ}_{M}} & ⋱ & {e}^{j ( M - 2 ) {θ}_{M}} & {e}^{j ( M - 1 ) {θ}_{M}} \\ 1 & {e}^{j 2 {θ}_{M}} & {e}^{j 4 {θ}_{M}} & & {e}^{j 2 ( \frac{M - 1}{2} - 1 ) {θ}_{M}} & {e}^{j 2 ( \frac{M - 1}{2} ) {θ}_{M}} & {e}^{j 2 ( \frac{M - 1}{2} + 1 ) {θ}_{M}} & {e}^{j 2 ( \frac{M - 1}{2} + 2 ) {θ}_{M}} & & {e}^{j 2 ( M - 2 ) {θ}_{M}} & {e}^{j 2 ( M - 1 ) {θ}_{M}} \\ ⋮ & ⋮ & ⋮ & ⋱ & ⋮ & ⋮ & & & ⋱ & ⋮ & ⋮ \\ 1 & {e}^{j ( M - 2 ) {θ}_{M}} & {e}^{j 2 ( M - 2 ) {θ}_{M}} & & {e}^{j ( \frac{M - 1}{2} - 1 ) ( \frac{M - 1}{2} - 1 ) {θ}_{M}} & {e}^{j ( M - 2 ) ( \frac{M - 1}{2} - 1 ) {θ}_{M}} & {e}^{j ( M - 2 ) ( \frac{M - 1}{2} + 1 ) {θ}_{M}} & {e}^{j ( M - 2 ) ( \frac{M - 1}{2} + 2 ) {θ}_{M}} & & {e}^{j ( M - 2 ) ( M - 2 ) {θ}_{M}} & {e}^{j ( M - 2 ) ( M - 1 ) {θ}_{M}} \\ 1 & {e}^{j ( M - 1 ) {θ}_{M}} & {e}^{j 2 ( M - 1 ) {θ}_{M}} & … & {e}^{j ( M - 1 ) ( \frac{M - 1}{2} - 1 ) {θ}_{M}} & {e}^{j ( M - 1 ) ( \frac{M - 1}{2} - 1 ) {θ}_{M}} & {e}^{j ( M - 1 ) ( \frac{M - 1}{2} + 1 ) {θ}_{M}} & {e}^{j ( M - 1 ) ( \frac{M - 1}{2} + 2 ) {θ}_{M}} & … & {e}^{j ( M - 2 ) ( M - 1 ) {θ}_{M}} & {e}^{j ( M - 1 ) ( M - 1 ) {θ}_{M}}\end{matrix} ] , \\ H = {[ \begin{matrix}H ( 0 ) & H ( 1 ) & H ( 2 ) & … & H ( m )\end{matrix} ]}^{T} {θ}_{M} = \frac{2 π}{M} , {\overline{θ}}_{M} = ( \frac{M - 1}{2} ) \frac{2 π}{M} .$$

Since h is assumed to be a real coefficient, the frequency response coefficient h(n) is usually designed using the real part of IDFT[H(k)]. Practically, FFT is used for calculation and the frequency response coefficient is obtained by h(n)=real(fft(H)).

There are also design methods for fractional order digital differentiators. For example, Republic of China, Taiwan, Patent No. I363490 obtains a fractional order digital differentiator model using differential evolution algorithm. However, the algorithm is complex and requires linger calculation time, and the digital differentiator's performance is difficult to enhance. China Patent No. CN1268232 significantly reduces the number of complex computations by DFT and IDFT by using the same computing device. However, a faster and simpler calculation is still missing. Therefore, increasing the calculation speed of the digital differentiator is still a major issue in practical applications.

### SUMMARY OF THE INVENTION

Compared to conventional design methods, the present invention provides an ideal frequency response function for a digital differentiator of any order K as follows:

$${H}^{( k )} ( w ) = {( jw )}^{K} = \{ \begin{matrix}{( - 1 )}^{\frac{K}{2}} {w}^{K} , & - π \leq w \leq π , & K is an even number \\ {j ( - 1 )}^{\frac{K - 1}{2}} {w}^{K} , & - π \leq w \leq π , & K is an odd number\end{matrix}$$

where w is frequency, H^{(K)}(w) is the value of Fourier transform (FT).

Assuming that the z-discrete transfer function of a linear-phased, digital signal processing system with real-coefficient, finite impulse response (FIR) having sampling point quantity M, such as a digital differentiator, is H(z)=Σₙ₌₀^{M-1}h(n)z⁻ⁿ where h(n) is the frequency response coefficient of the M-point FIR digital signal processing system (digital differentiator) and H(m) is the value of the M-point discrete Fourier transform (DFT). Since h(n) is real frequency response coefficient, the frequency response has conjugate symmetry:

$$H ( m ) = \{ \begin{matrix}H ( 0 ) , & m = 0 \\ {H}^{*} ( M - m ) , & 1 \leq m \leq M - 1\end{matrix} ,$$

where denotes conjugate complex number.

To achieve the above objective, the present invention provides a digital signal processing system, which may be a digital differentiator. The design method of the digital differentiator includes the following steps. Firstly, an order K is selected, where K is an integer. Then, the frequency response coefficient hₘ is set where m has a range 0≤m≤M−1 and M is the sampling point quantity. Then, for odd-numbered K and

$$\frac{K - 1}{2}$$

is also an odd number, the frequency response function H^{(K)}(w) is set to

$$\{ \begin{matrix}- {jw}^{K} , 0 \leq w < π \\ {jw}^{K} , - π \leq w \leq 0\end{matrix} ;$$

for odd-numbered K and

$$\frac{K - 1}{2}$$

is an even number, H^{(K)}(w) is set to

$$\{ \begin{matrix}{jw}^{K} , 0 \leq w < π \\ - {jw}^{K} , - π \leq w \leq 0\end{matrix} ;$$

for even-numbered K and

$$\frac{K}{2}$$

is an odd number, H^{(K)}(w) is set to −w^{K}, −π≤w<π; and for even-numbered K and

$$\frac{K}{2}$$

is an even number, H^{(K)}(w) is set to

$$\{ \begin{matrix}{jw}^{K} , 0 \leq w < π \\ - {jw}^{K} , - π \leq w \leq 0\end{matrix} .$$

To achieve the above objective, the present invention provides a digital differentiator of an order K with a frequency response coefficient hₘ and a frequency response function H^{(K)}(w), where m of hₘ has a range 0≤m≤M−1, M is the sampling point quantity, and H^{(K)}(w) is one of

$$\{ \begin{matrix}- {jw}^{K} , 0 \leq w < π \\ {jw}^{K} , - π \leq w \leq 0\end{matrix} , \{ \begin{matrix}{jw}^{K} , 0 \leq w < π \\ - {jw}^{K} , - π \leq w \leq 0\end{matrix} , - {w}^{K} , - π \leq w < π , and \\ \{ \begin{matrix}{jw}^{K} , 0 \leq w < π \\ - {jw}^{K} , - π \leq w \leq 0\end{matrix} ,$$

or combination thereof.

Compared to the prior art, the present invention provides a novel digital differentiator and a related design method through a frequency response function of conjugate symmetry.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred stuctural embodiment incorporating the principles of the present invention is shown by way of illustrative example.

### BRIEF DESCRIPTION OF THE DRAWINGS

FIG. 1 is an amplitude response diagram for a digital differentiator according to prior art design method where the dots are points to be interpolated.

FIG. 1A is an amplitude response diagram for an all-band digital diffeentiator with M=51, K=3 according to the present invention.

FIG. 1B is an amplitude response diagram for an all-band digital differentiator with M=101, K=7 according to the present invention.

FIG. 2A is an amplitude response diagram for an all-band digital differentiator with M=50, K=3 according to the present invention.

FIG. 2B is an amplitude response diagram for an all-band digital differentiator with M=1001, K=7 according to the present invention.

FIG. 3A is an amplitude response diagram for an all-band digital differentiator with M=51, K=1 according to the present invention.

FIG. 3B is an amplitude response diagram for an all-band digital diffeentiator with M=151, K=5 according to the present invention.

FIG. 4A is an amplitude response diagram for an all-band digital differentiator with M=50, K=1 according to the present invention.

FIG. 4B is an amplitude response diagram for an all-band digital differentiator with M=80, K=5 according to the present invention.

FIG. 5A is an amplitude response diagram for an all-band digital differentiator with M=51, K=2 according to the present invention.

FIG. 5B is an amplitude response diagram for an all-band digital differentiator with M=85, K=6 according to the present invention.

FIG. 6A is an amplitude response diagram for an all-bend digital differentiator with M=50, K=2 according to the present invention.

FIG. 6B is an amplitude response diagram for an all-band digital differntiator with M=150, K=6 according to the present invention.

FIG. 7A is an amplitude response diagram for an all-band digital diffeentiator with M=51, K=2 according to the present invention.

FIG. 7B is an amplitude response diagram for an all-band digital differentiator with M=201, K=6 according to the present invention.

FIG. 8A is an amplitude response diagram for an all-band digital diffeantiator with M=50, K=2 according to the present invention.

FIG. 8B is an amplitude response diagram for an all-band digital differentiator with M=200, K=6 according to the present invention.

FIG. 9 is an amplitude response diagram for a partial-band digital differentiator with M=201, N₁=81, K=3 according to the present invention.

FIG. 10 is an amplitude response diagram for a partial-band digital differentiator with M=451, N₁=91, K=7 according to the present invention.

FIG. 11 is an amplitude response diagram for a partial-band digital differentiator with M=100, N₁=35, K=3 according to the present invention.

FIG. 12 is an amplitude response diagram for a partial-band digital differentiator with M=151, N₁=57, K=1 according to the present invention.

FIG. 13 is an amplitude response diagram for a partial-band digital differentiator with M=100, N₁=30, K=5 according to the present invention.

FIG. 14 is an amplitude response diagram for a partial-band digital differentiator with M=101, N₁=41, K=2 according to the present invention.

FIG. 15 is an amplitude response diagram for a partial-band digital differentiator with M=200, N₁=60, K=6 according to the present invention.

FIG. 16 is an amplitude response diagram for a partial-bend digital differentiator with M=201, N₁=86, K=4 according to the present invention.

FIG. 17 is an amplitude response diagram for a partial-band digital differentiator with M=100, N₁=48, K=8 according to the present invention.

FIG. 18 is a transfer function block diagram for a linear-phased digital differentiator with M=7.

FIG. 19 is an operational block diagram of a direct type FIR differantiator.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

When discrete Fourier transform H(m) may be expressed as

$$H ( m ) = {H}_{r} ( \frac{2 π m}{M} ) {e}^{j ∠ H ( m )} ,$$

∠H(m) is the phase function, the amplitude response

$$\vert {H}_{r} ( \frac{2 π m}{M} ) \vert$$

is a real-coefficient function, and

$${H}_{r} ( \frac{2 π m}{M} ) = \{ \begin{matrix}{H}_{r} ( 0 ) , & m = 0 \\ H ( \frac{2 π ( M - m )}{M} ) , & 1 \leq m \leq M - 1\end{matrix}$$

As the FIR digital signal processing system to be designed is linear-phased, the phase angle ∠H(m) is as follows if H(m) is symmetric:

$$∠ H ( m ) = \{ \begin{matrix}- ( \frac{M - 1}{2} ) ( \frac{2 π m}{M} ) , & m = 0 , 1 , … , ⌊ \frac{M - 1}{2} ⌋ \\ ( \frac{M - 1}{2} ) ( \frac{2 π ( M - m )}{M} ) , & m = ⌊ \frac{M - 1}{2} ⌋ + 1 , … , M - 1\end{matrix} ;$$

the phase angle ∠H(m) is as follows if H(m) is symmetric:

$$∠ H ( m ) = \{ \begin{matrix}\pm \frac{π}{2} - ( \frac{M - 1}{2} ) ( \frac{2 π m}{M} ) , & m = 0 , 1 , … , ⌊ \frac{M - 1}{2} ⌋ \\ - ( \pm \frac{π}{2} ) + ( \frac{M - 1}{2} ) ( \frac{2 π ( M - m )}{M} ) , & m = ⌊ \frac{M - 1}{2} ⌋ + 1 , … , M - 1\end{matrix} ;$$

wherein └m┘ is the largest integer less than or equal to m. Additionally, if H(m) is symmetric, Hₘ=H(m) and

$$∠ {H}_{m} = \{ \begin{matrix}- ( \frac{M - 1}{2} ) ( \frac{2 π m}{M} ) , & m = 0 , 1 , … , ⌊ \frac{M - 1}{2} ⌋ \\ ( \frac{M - 1}{2} ) ( \frac{2 π ( M - m )}{M} ) , & m = ⌊ \frac{M - 1}{2} ⌋ + 1 , … , M - 1\end{matrix} ;$$

whereas if H(m) is anti-symmetric, Hₘ=±jH(m) and

$$∠ {H}_{m} = \{ \begin{matrix}- ( \frac{M - 1}{2} ) ( \frac{2 π m}{M} ) , & m = 0 , 1 , … , ⌊ \frac{M - 1}{2} ⌋ \\ ( \frac{M - 1}{2} ) ( \frac{2 π ( M - m )}{M} ) , & m = ⌊ \frac{M - 1}{2} ⌋ + 1 , … , M - 1\end{matrix} .$$

Assuming that

$${θ}_{M} = \frac{2 π}{M} , α = \frac{M - 1}{2} , and {\overline{θ}}_{M} = ( \frac{M - 1}{2} ) \frac{2 π}{M} = α {θ}_{M} ,$$

then

$$\begin{matrix}{W}^{*} H = [ \begin{matrix}1 & 1 & 1 & … & 1 & 1 & … & 1 & 1 \\ 1 & {e}^{j {θ}_{M}} & {e}^{j 2 {θ}_{M}} & … & {e}^{j \frac{M - 1}{2} {θ}_{M}} & {e}^{j \frac{M + 1}{2} {θ}_{M}} & … & {e}^{j ( M - 2 ) {θ}_{M}} & {e}^{j ( M - 1 ) {θ}_{M}} \\ 1 & {e}^{2 j {θ}_{M}} & {e}^{2 j 2 {θ}_{M}} & … & {e}^{2 j \frac{M - 1}{2} {θ}_{M}} & {e}^{2 j \frac{M + 1}{2} {θ}_{M}} & … & {e}^{2 j ( M - 2 ) {θ}_{M}} & {e}^{2 j ( M - 1 ) {θ}_{M}} \\ ⋮ & & & & ⋱ & & ⋱ & & ⋮ \\ 1 & {e}^{( M - 2 ) j {θ}_{M}} & {e}^{( M - 2 ) j 2 {θ}_{M}} & … & {e}^{( M - 2 ) j \frac{M - 1}{2} {θ}_{M}} & {e}^{( M - 2 ) j \frac{M + 1}{2} {θ}_{M}} & … & {e}^{( M - 2 ) j ( M - 2 ) {θ}_{M}} & {e}^{( M - 2 ) j ( M - 1 ) {θ}_{M}} \\ 1 & {e}^{( M - 1 ) j {θ}_{M}} & {e}^{( M - 1 ) j 2 {θ}_{M}} & … & {e}^{( M - 1 ) j \frac{M - 1}{2} {θ}_{M}} & {e}^{( M - 1 ) j \frac{M + 1}{2} {θ}_{M}} & … & {e}^{( M - 1 ) j ( M - 2 ) {θ}_{M}} & {e}^{( M - 1 ) j ( M - 1 ) {θ}_{M}}\end{matrix} ] \\ [ \begin{matrix}{H}_{0} {e}^{0 j {\overline{θ}}_{M}} \\ {H}_{1} {e}^{- j {\overline{θ}}_{M}} \\ {H}_{2} {e}^{- 2 j {\overline{θ}}_{M}} \\ ⋮ \\ {H}_{\frac{M - 1}{2}} {e}^{- \frac{M - 1}{2} j {\overline{θ}}_{M}} \\ {H}_{\frac{M - 1}{2}} {e}^{\frac{M + 1}{2} j {\overline{θ}}_{M}} \\ ⋮ \\ {H}_{M - 2} {e}^{2 j {\overline{θ}}_{M}} \\ {H}_{M - 1} {e}^{j {\overline{θ}}_{M}}\end{matrix} ] \\ = [ \begin{matrix}{H}_{0} + {H}_{1} {e}^{- j {\overline{θ}}_{M}} + {H}_{2} {e}^{- 2 j {\overline{θ}}_{M}} + … + {H}_{M - 2} {e}^{2 j {\overline{θ}}_{M}} + {H}_{M - 1} {e}^{j {\overline{θ}}_{M}} \\ {H}_{0} + {H}_{1} {e}^{j ( {θ}_{M} - {\overline{θ}}_{M} )} + {H}_{2} {e}^{j ( 2 {θ}_{M} - 2 {\overline{θ}}_{M} )} + … + {H}_{M - 2} {e}^{j ( ( M - 2 ) {θ}_{M} + 2 {\overline{θ}}_{M} )} + {H}_{M - 1} {e}^{j ( ( M - 1 ) {θ}_{M} + {\overline{θ}}_{M} )} \\ {H}_{0} + {H}_{1} {e}^{j ( 2 {θ}_{M} - {\overline{θ}}_{M} )} + {H}_{2} {e}^{j ( 2 \cdot 2 {θ}_{M} - {\overline{θ}}_{M} )} + … + {H}_{M - 2} {e}^{j ( 2 ( M - 2 ) {θ}_{M} + 2 {\overline{θ}}_{M} )} + {H}_{M - 1} {e}^{j ( 2 ( M - 1 ) {θ}_{M} + {\overline{θ}}_{M} )} \\ ⋮ \\ {H}_{0} + {H}_{1} {e}^{j ( ( M - 2 ) {θ}_{M} - {\overline{θ}}_{M} )} + {H}_{2} {e}^{j ( 2 ( M - 2 ) {θ}_{M} - 2 {\overline{θ}}_{M} )} + … + {H}_{M - 2} {e}^{j ( ( M - 2 ) ( M - 2 ) {θ}_{M} + 2 {\overline{θ}}_{M} )} + {H}_{M - 1} {e}^{j ( ( M - 1 ) ( M - 2 ) {θ}_{M} + {\overline{θ}}_{M} )} \\ {H}_{0} + {H}_{1} {e}^{j ( ( M - 1 ) {θ}_{M} - {\overline{θ}}_{M} )} + {H}_{2} {e}^{j ( 2 ( M - 1 ) {θ}_{M} - 2 {\overline{θ}}_{M} )} + … + {H}_{M - 2} {e}^{j ( ( M - 2 ) ( M - 1 ) {θ}_{M} + 2 {\overline{θ}}_{M} ]} + {H}_{M - 1} {e}^{j ( ( M - 1 ) ( M - 1 ) {θ}_{M} + {\overline{θ}}_{M} )}\end{matrix} ]\end{matrix} \qquad ( 1 )$$

If the digital processing system to be designed is a FIR digital differentiator, ∠Hₘ and W*H is identical to the above, and details are therefore omitted.

If H(m) is symmetric and M is an odd number, W*H may be obtained using equation (1) as follows:

$$\begin{matrix}{W}^{*} H = [ \begin{matrix}{H}_{0} + ( {H}_{1} {e}^{- j {\overline{θ}}_{M}} + {H}_{M - 1} {e}^{j {\overline{θ}}_{M}} ) + ( {H}_{2} {e}^{- 2 j {\overline{θ}}_{M}} + {H}_{M - 2} {e}^{2 j {\overline{θ}}_{M}} ) + … + ( {H}_{\frac{M - 1}{2}} {e}^{- j \frac{M - 1}{2} {\overline{θ}}_{M}} + {H}_{\frac{M + 1}{2}} {e}^{j \frac{M - 1}{2} {\overline{θ}}_{M}} ) \\ {H}_{0} + ( {H}_{1} {e}^{j ( {θ}_{M} - {\overline{θ}}_{M} )} + {H}_{M - 1} {e}^{j [ ( M - 1 ) {θ}_{M} + {\overline{θ}}_{M} ]} ) + … + ( {H}_{\frac{M - 1}{2}} {e}^{j ( \frac{M - 1}{2} {θ}_{M} - \frac{M - 1}{2} {\overline{θ}}_{M} )} + {H}_{\frac{M + 1}{2}} {e}^{j [ \frac{M + 1}{2} {θ}_{M} + \frac{M - 1}{2} {\overline{θ}}_{M} ]} ) \\ {H}_{0} + ( {H}_{1} {e}^{j ( 2 {θ}_{M} - {\overline{θ}}_{M} )} + {H}_{M - 1} {e}^{j [ 2 ( M - 1 ) {θ}_{M} - {\overline{θ}}_{M} ]} ) + … + ( {H}_{\frac{M - 1}{2}} {e}^{j ( 2 \cdot \frac{M - 1}{2} {θ}_{M} - \frac{M - 1}{2} {\overline{θ}}_{M} )} + {H}_{\frac{M + 1}{2}} {e}^{j [ 2 \cdot \frac{M - 1}{2} {θ}_{M} + \frac{M - 1}{2} {\overline{θ}}_{M} ]} ) \\ ⋮ \\ {H}_{0} + ( {H}_{1} {e}^{j ( ( M - 2 ) {θ}_{M} - {\overline{θ}}_{M} )} + {H}_{M - 1} {e}^{j [ ( M - 2 ) ( M - 1 ) {θ}_{M} + {\overline{θ}}_{M} ]} ) + … + ( {H}_{\frac{M - 1}{2}} {e}^{j [ \frac{M - 1}{2} ( M - 2 ) {θ}_{M} - \frac{M - 1}{2} {\overline{θ}}_{M} ]} + {H}_{\frac{M + 1}{2}} {e}^{j [ \frac{M - 1}{2} ( M - 2 ) {θ}_{M} + \frac{M - 1}{2} {\overline{θ}}_{M} ]} ) \\ {H}_{0} + ( {H}_{1} {e}^{j ( ( M - 1 ) {θ}_{M} - {\overline{θ}}_{M} )} + {H}_{M - 1} {e}^{j [ ( M - 1 ) ( M - 1 ) {θ}_{M} + {\overline{θ}}_{M} ]} ) + … + ( {H}_{\frac{M - 1}{2}} {e}^{j [ \frac{M - 1}{2} ( M - 1 ) {θ}_{M} - \frac{M - 1}{2} {\overline{θ}}_{M} ]} + {H}_{\frac{M + 1}{2}} {e}^{j [ \frac{M + 1}{2} ( M - 1 ) {θ}_{M} + \frac{M - 1}{2} {\overline{θ}}_{M} ]} )\end{matrix} ] \\ = [ \begin{matrix}2 {( \frac{2 π}{M} )}^{K} cos {\overline{θ}}_{M} + 2 {( \frac{2 π \cdot 2}{M} )}^{K} cos 2 {\overline{θ}}_{M} + … + 2 {( \frac{2 π \frac{M - 1}{2}}{M} )}^{K} cos \frac{M - 1}{2} {\overline{θ}}_{M} \\ 2 {( \frac{2 π}{M} )}^{K} cos ( {θ}_{M} - {\overline{θ}}_{M} ) + 2 {( \frac{2 π \cdot 2}{M} )}^{K} cos ( 2 {θ}_{M} - 2 {\overline{θ}}_{M} ) + … + 2 {( \frac{2 π \frac{M - 1}{2}}{M} )}^{K} cos ( \frac{M - 1}{2} {θ}_{M} - \frac{M - 1}{2} {\overline{θ}}_{M} ) \\ 2 {( \frac{2 π}{M} )}^{K} cos ( 2 {θ}_{M} - {\overline{θ}}_{M} ) + 2 {( \frac{2 π \cdot 2}{M} )}^{K} cos ( 2 \cdot 2 {θ}_{M} - 2 {\overline{θ}}_{M} ) + … + 2 {( \frac{2 π \frac{M - 1}{2}}{M} )}^{K} cos ( 2 \cdot \frac{M - 1}{2} {θ}_{M} - \frac{M - 1}{2} {\overline{θ}}_{M} ) \\ ⋮ \\ 2 {( \frac{2 π}{M} )}^{K} cos ( ( M - 2 ) {θ}_{M} - {\overline{θ}}_{M} ) + 2 {( \frac{2 π \cdot 2}{M} )}^{K} cos ( 2 ( M - 2 ) {θ}_{M} - 2 {\overline{θ}}_{M} ) + … + 2 {( \frac{2 π \frac{M - 1}{2}}{M} )}^{K} cos ( \frac{M - 1}{2} ( M - 2 ) \frac{M - 1}{2} {θ}_{M} - \frac{M - 1}{2} {\overline{θ}}_{M} ) \\ 2 {( \frac{2 π}{M} )}^{K} cos ( ( M - 1 ) {θ}_{M} - {\overline{θ}}_{M} ) + 2 {( \frac{2 π \cdot 2}{M} )}^{K} cos ( 2 ( M - 1 ) {θ}_{M} - 2 {\overline{θ}}_{M} ) + … + 2 {( \frac{2 π \frac{M - 1}{2}}{M} )}^{K} cos ( \frac{M - 1}{2} ( M - 1 ) \frac{M - 1}{2} {θ}_{M} - \frac{M - 1}{2} {\overline{θ}}_{M} )\end{matrix} ]\end{matrix} \qquad ( 2 )$$

When M is an even number, W*H may be obtained using equation (1) as follows:

$$[ \begin{matrix}{H}_{0} + ( {H}_{1} {e}^{- j {\overline{θ}}_{M}} + {H}_{M - 1} {e}^{j {\overline{θ}}_{M}} ) + … + ( {H}_{\frac{M}{2} - 1} {e}^{- j ( \frac{M}{2} - 1 ) {\overline{θ}}_{M}} + {H}_{\frac{M}{2} - 1} {e}^{j ( \frac{M}{2} - 1 ) {\overline{θ}}_{M}} ) \\ {H}_{0} + ( {H}_{1} {e}^{j ( {θ}_{M} - {\overline{θ}}_{M} )} + {H}_{M - 1} {e}^{j ( ( M - 1 ) {θ}_{M} + {\overline{θ}}_{M} )} ) + … + ( {H}_{\frac{M}{2} - 1} {e}^{j [ ( \frac{M}{2} - 1 ) {θ}_{M} - ( \frac{M}{2} - 1 ) {\overline{θ}}_{M} ]} + {H}_{\frac{M}{2} + 1} {e}^{j [ ( \frac{M}{2} + 1 ) {θ}_{M} + ( \frac{M}{2} - 1 ) {\overline{θ}}_{M} ]} ) \\ {H}_{0} + ( {H}_{1} {e}^{j ( 2 {θ}_{M} - {\overline{θ}}_{M} )} + {H}_{M - 1} {e}^{j ( 2 ( M - 1 ) {θ}_{M} + {\overline{θ}}_{M} )} ) + … + ( {H}_{\frac{M}{2} - 1} {e}^{j [ ( \frac{M}{2} - 1 ) \cdot 2 {θ}_{M} - ( \frac{M}{2} - 1 ) {\overline{θ}}_{M} ]} + {H}_{\frac{M}{2} + 1} {e}^{j [ ( \frac{M}{2} + 1 ) \cdot 2 {θ}_{M} + ( \frac{M}{2} - 1 ) {\overline{θ}}_{M} ]} ) \\ ⋮ \\ {H}_{0} + ( {H}_{1} {e}^{j ( ( M - 2 ) {θ}_{M} - {\overline{θ}}_{M} )} + {H}_{M - 1} {e}^{j ( ( M - 2 ) ( M - 1 ) {θ}_{M} + {\overline{θ}}_{M} )} ) + … + ( {H}_{\frac{M}{2} - 1} {e}^{j [ ( \frac{M}{2} - 1 ) ( M - 2 ) {θ}_{M} - ( \frac{M}{2} - 1 ) {\overline{θ}}_{M} ]} + {H}_{\frac{M}{2} + 1} {e}^{j [ ( \frac{M}{2} - 1 ) ( M - 2 ) {θ}_{M} + ( \frac{M}{2} - 1 ) {\overline{θ}}_{M} ]} ) \\ {H}_{0} + ( {H}_{1} {e}^{j ( ( M - 1 ) {θ}_{M} - {\overline{θ}}_{M} )} + {H}_{M - 1} {e}^{j ( ( M - 1 ) ( M - 1 ) {θ}_{M} + {\overline{θ}}_{M} )} ) + … + ( {H}_{\frac{M}{2} - 1} {e}^{j [ ( \frac{M}{2} - 1 ) ( M - 1 ) {θ}_{M} - ( \frac{M}{2} - 1 ) {\overline{θ}}_{M} ]} + {H}_{\frac{M}{2} + 1} {e}^{j [ ( \frac{M}{2} + 1 ) ( M - 1 ) {θ}_{M} + ( \frac{M}{2} - 1 ) {\overline{θ}}_{M} ]} )\end{matrix} ] + [ \begin{matrix}{H}_{\frac{M}{2}} {e}^{j \frac{M}{2} {\overline{θ}}_{M}} \\ {H}_{\frac{M}{2}} {e}^{j ( \frac{M}{2} {θ}_{M} + \frac{M}{2} {\overline{θ}}_{M} )} \\ {H}_{\frac{M}{2}} {e}^{j ( \frac{M}{2} \cdot 2 {θ}_{M} + \frac{M}{2} {\overline{θ}}_{M} )} \\ ⋮ \\ {H}_{\frac{M}{2}} {e}^{j ( \frac{M}{2} ( M - 2 ) {θ}_{M} + \frac{M}{2} {\overline{θ}}_{M} )} \\ {H}_{\frac{M}{2}} {e}^{j ( \frac{M}{2} ( M - 1 ) {θ}_{M} + \frac{M}{2} {\overline{θ}}_{M} )}\end{matrix} ] = [ \begin{matrix}2 {( \frac{2 π}{M} )}^{K} cos {\overline{θ}}_{M} + 2 {( \frac{2 π \cdot 2}{M} )}^{K} cos 2 {\overline{θ}}_{M} + … + 2 {( \frac{2 π \frac{M}{2} - 1}{M} )}^{K} cos ( \frac{M}{2} - 1 ) {\overline{θ}}_{M} \\ 2 {( \frac{2 π}{M} )}^{K} cos ( {θ}_{M} - {\overline{θ}}_{M} ) + 2 {( \frac{2 π \cdot 2}{M} )}^{K} cos ( 2 {θ}_{M} - 2 {\overline{θ}}_{M} ) + … + 2 {( \frac{2 π \frac{M}{2} - 1}{M} )}^{K} cos ( ( \frac{M}{2} - 1 ) {θ}_{M} - ( \frac{M}{2} - 1 ) {\overline{θ}}_{M} ) \\ 2 {( \frac{2 π}{M} )}^{K} cos ( 2 {θ}_{M} - {\overline{θ}}_{M} ) + 2 {( \frac{2 π \cdot 2}{M} )}^{K} cos ( 2 \cdot 2 {θ}_{M} - 2 {\overline{θ}}_{M} ) + … + 2 {( \frac{2 π \frac{M}{2} - 1}{M} )}^{K} cos ( 2 ( \frac{M}{2} - 1 ) {θ}_{M} - ( \frac{M}{2} - 1 ) {\overline{θ}}_{M} ) \\ ⋮ \\ 2 {( \frac{2 π}{M} )}^{K} cos ( ( M - 2 ) {θ}_{M} - {\overline{θ}}_{M} ) + 2 {( \frac{2 π \cdot 2}{M} )}^{K} cos ( 2 ( M - 2 ) {θ}_{M} - 2 {\overline{θ}}_{M} ) + … + 2 {( \frac{2 π \frac{M}{2} - 1}{M} )}^{K} cos ( ( M - 2 ) ( \frac{M}{2} - 1 ) {θ}_{M} - ( \frac{M}{2} - 1 ) {\overline{θ}}_{M} ) \\ 2 {( \frac{2 π}{M} )}^{K} cos ( ( M - 1 ) {θ}_{M} - {\overline{θ}}_{M} ) + 2 {( \frac{2 π \cdot 2}{M} )}^{K} cos ( 2 ( M - 1 ) {θ}_{M} - 2 {\overline{θ}}_{M} ) + … + 2 {( \frac{2 π \frac{M}{2} - 1}{M} )}^{K} cos ( ( M - 1 ) ( \frac{M}{2} - 1 ) {θ}_{M} - ( \frac{M}{2} - 1 ) {\overline{θ}}_{M} )\end{matrix} ] + [ \begin{matrix}{( \frac{2 π \cdot \frac{M}{2}}{M} )}^{K} {e}^{j \frac{M}{2} {\overline{θ}}_{M}} \\ {( \frac{2 π \cdot \frac{M}{2}}{M} )}^{K} {e}^{j ( \frac{M}{2} {θ}_{M} + \frac{M}{2} {\overline{θ}}_{M} )} \\ {( \frac{2 π \cdot \frac{M}{2}}{M} )}^{K} {e}^{j ( \frac{M}{2} \cdot 2 {θ}_{M} + \frac{M}{2} {\overline{θ}}_{M} )} \\ ⋮ \\ {( \frac{2 π \cdot \frac{M}{2}}{M} )}^{K} {e}^{j ( \frac{M}{2} ( M - 2 ) {θ}_{M} + \frac{M}{2} {\overline{θ}}_{M} )} \\ {( \frac{2 π \cdot \frac{M}{2}}{M} )}^{K} {e}^{j ( \frac{M}{2} ( M - 1 ) {θ}_{M} + \frac{M}{2} {\overline{θ}}_{M} )}\end{matrix} ] \qquad ( 3 )$$

If H(m) is anti-symnmetric and M is an odd number, W*H may be obtained usinig equation (1) as follows:

$${W}^{*} H == [ \begin{matrix}- 2 {j ( \frac{2 π}{M} )}^{K} sin {\overline{θ}}_{M } - 2 {j ( \frac{2 π \cdot 2}{M} )}^{K} sin 2 {\overline{θ}}_{M} - … - 2 {j ( \frac{2 π \cdot \frac{M - 1}{2}}{M} )}^{K} sin \frac{M - 1}{2} {\overline{θ}}_{M} \\ 2 {j ( \frac{2 π}{M} )}^{K} sin ( {θ}_{M} - {\overline{θ}}_{M} ) + 2 {j ( \frac{2 π \cdot 2}{M} )}^{K} sin ( 2 {θ}_{M} - 2 {\overline{θ}}_{M} ) + … + 2 {j ( \frac{2 π \cdot \frac{M - 1}{2}}{M} )}^{K} sin ( \frac{M - 1}{2} {θ}_{M} - \frac{M - 1}{2} {\overline{θ}}_{M} ) \\ 2 {j ( \frac{2 π}{M} )}^{K} sin ( 2 {θ}_{M} - {\overline{θ}}_{M} ) + 2 {j ( \frac{2 π \cdot 2}{M} )}^{K} sin ( 2 \cdot 2 {θ}_{M} - 2 {\overline{θ}}_{M} ) + … + 2 {j ( \frac{2 π \cdot \frac{M - 1}{2}}{M} )}^{K} sin ( 2 \cdot \frac{M - 1}{2} {θ}_{M} - \frac{M - 1}{2} {\overline{θ}}_{M} ) \\ ⋮ \\ 2 {j ( \frac{2 π}{M} )}^{K} sin ( ( M - 2 ) {θ}_{M} - {\overline{θ}}_{M} ) + 2 {j ( \frac{2 π \cdot 2}{M} )}^{K} sin ( 2 ( M - 2 ) {θ}_{M} - 2 {\overline{θ}}_{M} ) + … + 2 {j ( \frac{2 π \cdot \frac{M - 1}{2}}{M} )}^{K} sin ( \frac{M - 1}{2} ( M - 2 ) {θ}_{M} - \frac{M - 1}{2} {\overline{θ}}_{M} ) \\ 2 {j ( \frac{2 π}{M} )}^{K} sin ( ( M - 1 ) {θ}_{M} - {\overline{θ}}_{M} ) + 2 {j ( \frac{2 π \cdot 2}{M} )}^{K} sin ( 2 ( M - 1 ) {θ}_{M} - 2 {\overline{θ}}_{M} ) + … + 2 {j ( \frac{2 π \cdot \frac{M - 1}{2}}{M} )}^{K} sin ( \frac{M - 1}{2} ( M - 1 ) {θ}_{M} - \frac{M - 1}{2} {\overline{θ}}_{M} )\end{matrix} ] \qquad ( 4 )$$

When M is an even number, W*H may be obtained using equation (1) as follows:

$$= [ \begin{matrix}- 2 {j ( \frac{2 π}{M} )}^{K} sin {\overline{θ}}_{M } - 2 {j ( \frac{2 π \cdot 2}{M} )}^{K} sin 2 {\overline{θ}}_{M} - … - 2 {j ( \frac{2 π ( \frac{M}{2} - 1 )}{M} )}^{K} sin ( \frac{M}{2} - 1 ) {\overline{θ}}_{M} \\ 2 {j ( \frac{2 π}{M} )}^{K} sin ( {θ}_{M} - {\overline{θ}}_{M} ) + 2 {j ( \frac{2 π \cdot 2}{M} )}^{K} sin ( 2 {θ}_{M} - 2 {\overline{θ}}_{M} ) + … + 2 {j ( \frac{2 π ( \frac{M}{2} - 1 )}{M} )}^{K} sin ( ( \frac{M}{2} - 1 ) {θ}_{M} - ( \frac{M}{2} - 1 ) {\overline{θ}}_{M} ) \\ 2 {j ( \frac{2 π}{M} )}^{K} sin ( 2 {θ}_{M} - {\overline{θ}}_{M} ) + 2 {j ( \frac{2 π \cdot 2}{M} )}^{K} sin ( 2 \cdot 2 {θ}_{M} - 2 {\overline{θ}}_{M} ) + … + 2 {j ( \frac{2 π ( \frac{M}{2} - 1 )}{M} )}^{K} sin ( 2 ( \frac{M}{2} - 1 ) {θ}_{M} - ( \frac{M}{2} - 1 ) {\overline{θ}}_{M} ) \\ ⋮ \\ 2 {j ( \frac{2 π}{M} )}^{K} sin ( ( M - 2 ) {θ}_{M} - {\overline{θ}}_{M} ) + 2 {j ( \frac{2 π \cdot 2}{M} )}^{K} sin ( 2 ( M - 2 ) {θ}_{M} - 2 {\overline{θ}}_{M} ) + … + 2 {j ( \frac{2 π ( \frac{M}{2} - 1 )}{M} )}^{K} sin ( ( M - 2 ) ( \frac{M}{2} - 1 ) {θ}_{M} - ( \frac{M}{2} - 1 ) {\overline{θ}}_{M} ) \\ 2 {j ( \frac{2 π}{M} )}^{K} sin ( ( M - 1 ) {θ}_{M} - {\overline{θ}}_{M} ) + 2 {j ( \frac{2 π \cdot 2}{M} )}^{K} sin ( 2 ( M - 1 ) {θ}_{M} - 2 {\overline{θ}}_{M} ) + … + 2 {j ( \frac{2 π ( \frac{M}{2} - 1 )}{M} )}^{K} sin ( ( M - 1 ) ( \frac{M}{2} - 1 ) {θ}_{M} - ( \frac{M}{2} - 1 ) {\overline{θ}}_{M} )\end{matrix} ] + [ \begin{matrix}{( \frac{2 π \cdot \frac{M}{2}}{M} )}^{K} {e}^{j \frac{M}{2} {\overline{θ}}_{M}} \\ {( \frac{2 π \cdot \frac{M}{2}}{M} )}^{K} {e}^{j ( \frac{M}{2} {θ}_{M} + \frac{M}{2} {\overline{θ}}_{M} )} \\ {( \frac{2 π \cdot \frac{M}{2}}{M} )}^{K} {e}^{j ( \frac{M}{2} \cdot 2 {θ}_{M} + \frac{M}{2} {\overline{θ}}_{M} )} \\ ⋮ \\ {( \frac{2 π \cdot \frac{M}{2}}{M} )}^{K} {e}^{j ( \frac{M}{2} ( M - 2 ) {θ}_{M} + \frac{M}{2} {\overline{θ}}_{M} )} \\ {( \frac{2 π \cdot \frac{M}{2}}{M} )}^{K} {e}^{j ( \frac{M}{2} ( M - 1 ) {θ}_{M} + \frac{M}{2} {\overline{θ}}_{M} )}\end{matrix} ] \qquad ( 5 )$$

Then, Σₙ₌₁^{M} n^{K} sin nθ is expanded as follows:

$${\sum }_{n = 1}^{M} {n}^{K} sin n θ = sin θ + {2}^{K} sin 2 θ + {3}^{K} sin 3 θ + 4 K sin 4 θ + … + {M}^{K} sin M θ = sin θ + sin 2 θ + sin 3 θ + sin 4 θ + … + sin M θ + ( {2}^{K + 1} - 1 ) sin 2 θ + ( {3}^{K + 1} - 1 ) sin 3 θ + ( {4}^{K + 1} - 1 ) sin 4 θ + … + ( {M}^{K + 1} - 1 ) sin M θ = {\sum }_{n = 1}^{M} sin n θ ++ ( {2}^{K} - 1 ) sin 2 θ + ( {2}^{K} - 1 ) sin 3 θ + ( {2}^{K} - 1 ) sin 4 θ + … + ( {2}^{K} - 1 ) sin M θ + [ ( {3}^{K} - 1 ) - ( {2}^{K} - 1 ) ] sin 3 θ + [ ( {4}^{K} - 1 ) - ( {2}^{K} - 1 ) ] sin 4 θ + … + [ ( {M}^{K} - 1 ) - ( {2}^{K} - 1 ) ] sin M θ = {\sum }_{n = 1}^{M} sin n θ + ( {2}^{K} - 1 ) {\sum }_{n = 2}^{M} sin n θ + ( {3}^{K} - {2}^{K} ) sin 3 θ + ( {3}^{K} - {2}^{K} ) sin 4 θ + ( {3}^{K} - {2}^{K} ) sin 4 θ + ( {3}^{K} - {2}^{K} ) sin 5 θ + … + ( {3}^{K} - {2}^{K} ) sin M θ + [ ( {4}^{K} - {2}^{K} ) - ( {3}^{K} - {2}^{K} ) ] sin 4 θ + [ ( {5}^{K} - {2}^{K} ) - ( {3}^{K} - {2}^{K} ) ] sin 5 θ + … + [ ( {M}^{K} - {2}^{K} ) - ( {3}^{K} - {2}^{K} ) ] sin M θ = {\sum }_{n = 1}^{M} sin n θ + ( {2}^{K} - 1 ) {\sum }_{n = 2}^{M} sin n θ + ( {3}^{K} - {2}^{K} ) {\sum }_{n = 1}^{M} sin n θ + ( {4}^{K} - {3}^{K} ) sin 4 θ + ( {4}^{K} - {3}^{K} ) sin 5 θ + … + ( {4}^{K} - {3}^{K} ) sin M θ + [ ( {5}^{K} - {3}^{K} ) - ( {4}^{K} - {3}^{K} ) ] sin 5 θ + [ ( {6}^{K} - {3}^{K} ) ( {4}^{K} - {3}^{K} ) ] sin 6 θ + … + [ ( {M}^{K} - {3}^{K} ) - ( {4}^{K} - {3}^{K} ) ] sin M θ = {\sum }_{n = 1}^{M} sin n θ + ( {2}^{K} - 1 ) {\sum }_{n = 2}^{M} sin n θ + ( {3}^{K} - {2}^{K} ) {\sum }_{n = 3}^{M} sin n θ + ( {4}^{K} - {3}^{K} ) {\sum }_{n = 4}^{M} sin n θ + [ ( {5}^{K} - {3}^{K} ) - ( {4}^{K} - {3}^{K} ) ] sin 5 θ + [ ( {6}^{K} - {3}^{K} ) ( {4}^{K} - {3}^{K} ) ] sin 6 θ + … + [ ( {M}^{K} - {3}^{K} ) - ( {4}^{K} - {3}^{K} ) ] sin M θ$$

### Therefore,

$${\sum }_{n = 1}^{M} {n}^{K} sin n θ = {\sum }_{n = 1}^{M} sin n θ + ( {2}^{K} - 1 ) {\sum }_{n = 2}^{M} sin n θ + ( {3}^{K} - {2}^{K} ) {\sum }_{n = 3}^{M} sin n θ + … + ( {M}^{K} - {( M - 1 )}^{K} ) {\sum }_{n = M - 1}^{M} sin M θ = {\sum }_{n = 1}^{M} ( {n}^{K} - {( n - 1 )}^{K} ) {\sum }_{m = n}^{M} sin m θ$$

$$and$$

$${\sum }_{n = 1}^{M} {n}^{K} sin n θ = {\sum }_{n = 1}^{M} {\sum }_{m = n}^{M} sin m θ ( {n}^{K} - {( n - 1 )}^{K} )$$

### Also,

$${\sum }_{n = 1}^{N} sin n θ = \frac{cos \frac{θ}{2} - cos ( N + \frac{1}{2} θ )}{2 sin \frac{θ}{2}} {\sum }_{n = {N}_{1}}^{{N}_{2}} sin n θ = \frac{cos ( {N}_{1} - \frac{1}{2} ) θ - cos ( {N}_{2} + \frac{1}{2} ) θ}{2 sin \frac{θ}{2}} = \frac{sin \frac{{N}_{2} + {N}_{1}}{2} θ sin \frac{{N}_{2} - {N}_{1} + 1}{2} θ}{sin \frac{θ}{2}}$$

$$If {θ}_{m}^{M} = m {θ}_{M} - {\overline{θ}}_{M} , then$$

$${\sum }_{m = {N}_{1}}^{{N}_{2}} sin m ( m {θ}_{M} - {\overline{θ}}_{M} ) = {\sum }_{m = {N}_{1}}^{{N}_{2}} sin m {θ}_{m}^{M} = \frac{cos ( ( {N}_{1} - \frac{1}{2} ) ( m {θ}_{M} - {\overline{θ}}_{M} ) ) - cos ( ( {N}_{2} + \frac{1}{2} ) ( m {θ}_{M} - {\overline{θ}}_{M} ) )}{2 sin \frac{1}{2} ( m {θ}_{M} - {\overline{θ}}_{M} )} = \frac{sin ( \frac{1}{2} ( {N}_{1} + {N}_{2} ) ( m {θ}_{M} - {\overline{θ}}_{M} ) ) sin ( \frac{1}{2} ( {N}_{2} - {N}_{1} + 1 ) ( m {θ}_{M} - {\overline{θ}}_{M} ) )}{sin \frac{1}{2} ( m {θ}_{M} - {\overline{θ}}_{M} )}$$

### Especially,

$${\sum }_{l = n}^{M} sin l ( m {θ}_{M} - {\overline{θ}}_{M} ) = {\sum }_{l = n}^{M} sin l {θ}_{m}^{M} = \frac{cos ( ( n - \frac{1}{2} ) ( m {θ}_{M} - {\overline{θ}}_{M} ) ) - cos ( ( M + \frac{1}{2} ) ( m {θ}_{M} - {\overline{θ}}_{M} ) )}{2 sin \frac{1}{2} ( m {θ}_{M} - {\overline{θ}}_{M} )} = \frac{sin ( \frac{1}{2} ( M + n ) ( m {θ}_{M} - {\overline{θ}}_{M} ) ) sin ( \frac{1}{2} ( M - n + 1 ) ( m {θ}_{M} - {\overline{θ}}_{M} ) )}{sin \frac{1}{2} ( m {θ}_{M} - {\overline{θ}}_{M} )}$$

$${\sum }_{n = 1}^{M} {n}^{K} sin n ( m {θ}_{M} - {\overline{θ}}_{M} ) = {\sum }_{n = 1}^{M} {n}^{K} sin n {θ}_{m}^{M} = {\sum }_{n = 1}^{M} [ ( {n}^{K} - {( n - 1 )}^{K} ) {\sum }_{l = n}^{M} sin l {θ}_{m}^{M} ] = {\sum }_{n = 1}^{M} [ ( {n}^{K} - {( n - 1 )}^{K} ) \frac{cos ( ( n - \frac{1}{2} ) ( m {θ}_{M} - {\overline{θ}}_{M} ) ) - cos ( ( M + \frac{1}{2} ) ( m {θ}_{M} - {\overline{θ}}_{M} ) )}{2 sin \frac{1}{2} ( m {θ}_{M} - {\overline{θ}}_{M} )} ] = {\sum }_{n = 1}^{M} [ ( {n}^{K} - {( n - 1 )}^{K} ) \frac{sin ( \frac{1}{2} ( M + n ) ( m {θ}_{M} - {\overline{θ}}_{M} ) ) sin ( \frac{1}{2} ( M - n + 1 ) ( m {θ}_{M} - {\overline{θ}}_{M} ) )}{sin \frac{1}{2} ( m {θ}_{M} - {\overline{θ}}_{M} )} ]$$

Then Σₙ₌₁^{M} n^{K} cos nθ is expanded as follows:

$${\sum }_{n = 1}^{M} {n}^{K} cos n θ = cos θ + {2}^{K} cos 2 θ + {3}^{K} cos 3 θ + {4}^{K} cos 4 θ + … + {M}^{K} cos M θ = cos θ + cos 2 θ + cos 3 θ + cos 4 θ + … + cos M θ + ( {2}^{K + 1} - 1 ) cos 2 θ + ( {3}^{K + 1} - 1 ) cos 3 θ + ( {4}^{K + 1} - 1 ) cos 4 θ + … + ( {M}^{K + 1} - 1 ) cos M θ = {\sum }_{n = 1}^{M} cos n θ ++ ( {2}^{K} - 1 ) cos 2 θ + ( {2}^{K} - 1 ) cos 3 θ + ( {2}^{K} - 1 ) cos 4 θ + … + ( {2}^{K} - 1 ) cos M θ + [ ( {3}^{K} - 1 ) - ( {2}^{K} - 1 ) ] cos 3 θ + [ ( {4}^{K} - 1 ) - ( {2}^{K} - 1 ) ] cos 4 θ + … + [ ( {M}^{K} - 1 ) - ( {2}^{K} - 1 ) ] cos M θ = {\sum }_{n = 1}^{M} cos n θ + ( {2}^{K} - 1 ) {\sum }_{n = 2}^{M} cos n θ + ( {3}^{K} - {2}^{K} ) cos 3 θ + ( {3}^{K} - {2}^{K} ) cos 4 θ + ( {3}^{K} - {2}^{K} ) cos 5 θ + … + ( {3}^{K} - {2}^{K} ) cos M θ + [ ( {4}^{K} - {2}^{K} ) - ( {3}^{K} - {2}^{K} ) ] cos 4 θ + [ ( {5}^{K} - {2}^{K} ) - ( {3}^{K} - {2}^{K} ) ] cos 5 θ + … + [ ( {M}^{K} - {2}^{K} ) - ( {3}^{K} - {2}^{K} ) ] cos M θ = {\sum }_{n = 1}^{M} cos n θ + ( {2}^{K} - 1 ) {\sum }_{n = 2}^{M} cos n θ + ( {3}^{K} - {2}^{K} ) {\sum }_{n = 3}^{M} cos n θ + ( {4}^{K} - {3}^{K} ) cos 4 θ + ( {4}^{K} - {3}^{K} ) cos 5 θ + … + ( {4}^{K} - {3}^{K} ) cos M θ + [ ( {5}^{K} - {3}^{K} ) - ( {4}^{K} - {3}^{K} ) ] cos 5 θ + [ ( {6}^{K} - {3}^{K} ) ( {4}^{K} - {3}^{K} ) ] cos 6 θ + … + [ ( {M}^{K} - {3}^{K} ) - ( {4}^{K} - {3}^{K} ) ] cos M θ = {\sum }_{n = 1}^{M} cos n θ + ( {2}^{K} - 1 ) {\sum }_{n = 2}^{M} cos n θ + ( {3}^{K} - {2}^{K} ) {\sum }_{n = 3}^{M} cos n θ + ( {4}^{K} - {3}^{K} ) {\sum }_{n = 4}^{M} cos n θ + [ ( {5}^{K} - {3}^{K} ) - ( {4}^{K} - {3}^{K} ) ] cos 5 θ + [ ( {6}^{K} - {3}^{K} ) ( {4}^{K} - {3}^{K} ) ] cos 6 θ + … + [ ( {M}^{K} - {3}^{K} ) - ( {4}^{K} - {3}^{K} ) ] cos M θ$$

### Similarly,

$${\sum }_{n = 1}^{M} {n}^{K} cos n θ = {\sum }_{n = 1}^{M} cos n θ + ( {2}^{K} - 1 ) {\sum }_{n = 2}^{M} cos n θ + ( {3}^{K} - {2}^{K} ) {\sum }_{n = 3}^{M} cos n θ + … + ( {M}^{K} - {( M - 1 )}^{K} ) {\sum }_{n = M - 1}^{M} cos M θ = {\sum }_{n = 1}^{M} ( {n}^{K} - {( n - 1 )}^{K} ) {\sum }_{m = n}^{M} cos m θ$$

$$and$$

$${\sum }_{n = 1}^{M} {n}^{K} cos n θ = {\sum }_{n = 1}^{M} [ ( {n}^{K} - {( n - 1 )}^{K} ) {\sum }_{m = n}^{M} cos m θ ]$$

$$Also , \\ {\sum }_{n = 1}^{N} cos n θ = \frac{sin ( N + \frac{1}{2} ) θ}{2 sin \frac{θ}{2}} - \frac{1}{2} {\sum }_{n = {N}_{1}}^{{N}_{2}} cos n θ = \frac{sin ( {N}_{2} + \frac{1}{2} ) θ - sin ( {N}_{1} - \frac{1}{2} ) θ}{2 sin \frac{θ}{2}} = \frac{cos \frac{( {N}_{2} + {N}_{1} )}{2} θ sin \frac{{N}_{2} - {N}_{1} + 1}{2} θ}{sin \frac{θ}{2}}$$

$$If {θ}_{m}^{M} = m {θ}_{M} - {\overline{θ}}_{M} , then$$

$${\sum }_{m = n}^{M} cos m ( m {θ}_{M} - {\overline{θ}}_{M} ) = {\sum }_{m = n}^{M} cos m {θ}_{m}^{M} = \frac{sin ( M + n ) {θ}_{m}^{M} - sin ( n - \frac{1}{2} ) {θ}_{m}^{M}}{2 sin \frac{1}{2} {θ}_{m}^{M}} = \frac{cos \frac{( M + n )}{2} {θ}_{m}^{M} sin \frac{M - n + 1}{2} {θ}_{m}^{M}}{sin \frac{1}{2} {θ}_{m}^{M}} \\ {\sum }_{m = n}^{M} cos m ( m {θ}_{M} - {\overline{θ}}_{M} ) = \frac{sin ( M + \frac{1}{2} ) ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} = \frac{cos ( \frac{1}{2} ( M + n ) ( m {θ}_{M} - {\overline{θ}}_{M} ) ) sin ( \frac{1}{2} ( M - n + 1 ) ( m {θ}_{M} - {\overline{θ}}_{M} ) )}{sin \frac{1}{2} ( m {θ}_{M} - {\overline{θ}}_{M} )} . \\ Especially , \\ {\sum }_{n = 1}^{M} {n}^{k} cos n ( m {θ}_{M} - {\overline{θ}}_{M} ) = {\sum }_{n = 1}^{M} {n}^{k} cos n {θ}_{m}^{M} = {\sum }_{n = 1}^{M} [ ( {n}^{K} - {( n - 1 )}^{K} ) {\sum }_{l = n}^{M} cos l {θ}_{m}^{M} ] = {\sum }_{n = 1}^{M} [ ( {n}^{K} - {( n - 1 )}^{K} ) \frac{sin ( M + \frac{1}{2} ) ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} ] = {\sum }_{n = 1}^{M} [ ( {n}^{K} - {( n - 1 )}^{K} ) \frac{\begin{matrix}cos ( \frac{1}{2} ( M + n ) ( m {θ}_{M} - {\overline{θ}}_{M} ) ) \\ sin ( \frac{1}{2} ( M - n + 1 ) ( m {θ}_{M} - {\overline{θ}}_{M} ) )\end{matrix}}{sin \frac{1}{2} ( m {θ}_{M} - {\overline{θ}}_{M} )} ] .$$

For the design of an all-band digital differentiator of odd-numbered order (K is odd-numbered), if

$$\frac{K - 1}{2}$$

is an odd number, the frequency response function of the order-K differentiator is:

$${H}^{( K )} ( w ) = \{ \begin{matrix}- {jw}^{K} , & 0 \leq w < π \\ {jw}^{K} , & - π \leq w \leq 0\end{matrix}$$

The frequency response function of M sampling points H(m) may be expressed as

$$H ( m ) = {H}_{r} ( \frac{2 π m}{M} ) {e}^{j ∠ H ( m ) } ,$$

where

$${H}_{r} ( \frac{2 π m}{M} ) = \{ \begin{matrix}- {( \frac{2 π m}{M} )}^{K} , & m = 0 , 1 , … , ⌊ \frac{M - 1}{2} ⌋ \\ {( \frac{2 π ( M - m )}{M} )}^{K} , & m = ⌊ \frac{M - 1}{2} ⌋ + 1 , … , M - 1\end{matrix} .$$

The phase angle is:

$$∠ H ( m ) = \{ \begin{matrix}\frac{π}{2} - ( \frac{M - 1}{2} ) ( \frac{2 π m}{M} ) , & m = 0 , 1 , … , ⌊ \frac{M - 1}{2} ⌋ \\ - \frac{π}{2} + ( \frac{M - 1}{2} ) ( \frac{2 π ( M - m )}{M} ) , & m = ⌊ \frac{M - 1}{2} ⌋ + 1 , … , M - 1\end{matrix} ,$$

assuming

$${H}_{m} = \{ \begin{matrix}- {j ( \frac{2 π m}{M} )}^{K} , & m = 0 , 1 , … , ⌊ \frac{M - 1}{2} ⌋ \\ {j ( \frac{2 π ( M - m )}{M} )}^{K} , & m = ⌊ \frac{M - 1}{2} ⌋ + 1 , … , M - 1\end{matrix} \\ and \\ ∠ {H}_{m} = \{ \begin{matrix}- ( \frac{M - 1}{2} ) ( \frac{2 π m}{M} ) , & m = 0 , 1 , … , ⌊ \frac{M - 1}{2} ⌋ \\ ( \frac{M - 1}{2} ) ( \frac{2 π ( M - m )}{M} ) , & m = ⌊ \frac{M - 1}{2} ⌋ + 1 , … , M - 1\end{matrix}$$

If M is an odd number, the following may be obtained from equation (1):

$${W}^{*} H = [ \begin{matrix}- 2 j {\sum }_{n = 1}^{\frac{M - 1}{2}} {( \frac{2 π \cdot n}{M} )}^{K} sin n {\overline{θ}}_{M} ) \\ 2 j {\sum }_{n = 1}^{\frac{M - 1}{2}} {( \frac{2 π \cdot n}{M} )}^{K} sin n ( {θ}_{M} - {\overline{θ}}_{M} ) \\ 2 j {\sum }_{n = 1}^{\frac{M - 1}{2}} {( \frac{2 π \cdot n}{M} )}^{K} sin n ( 2 {θ}_{M} - {\overline{θ}}_{M} ) \\ ⋮ \\ 2 j {\sum }_{n = 1}^{\frac{M - 1}{2}} {( \frac{2 π \cdot n}{M} )}^{K} sin n ( ( M - 2 ) {θ}_{M} - {\overline{θ}}_{M} ) \\ 2 j {\sum }_{n = 1}^{\frac{M - 1}{2}} {( \frac{2 π \cdot n}{M} )}^{K} sin n ( ( M - 1 ) {θ}_{M} - {\overline{θ}}_{M} )\end{matrix} ]$$

$$and$$

$$h = {[ \begin{matrix}{h}_{0} & {h}_{1} & … & {h}_{M - 1}\end{matrix} ]}^{T} = \frac{1}{M} {W}^{*} H , \\ where$$

$$\begin{matrix}{h}_{m} = \frac{1}{M} [ 2 j {\sum }_{n = 1}^{\frac{M - 1}{2}} ( - j ) {( \frac{2 π \cdot n}{M} )}^{K} sin n ( m {θ}_{M} - {\overline{θ}}_{M} ) ] \\ = \frac{1}{M} [ 2 {( \frac{2 π}{M} )}^{K} {\sum }_{n = 1}^{\frac{M - 1}{2}} {n}^{K} sin n ( m {θ}_{M} - {\overline{θ}}_{M} ) ] \\ = \frac{1}{M} \{ 2 {( \frac{2 π}{M} )}^{K} {\sum }_{n = 1}^{\frac{M - 1}{2}} [ ( {n}^{K} - {( n - 1 )}^{K} ) {\sum }_{m = n}^{\frac{M - 1}{2}} sin m ( m {θ}_{M} - {\overline{θ}}_{M} ) ] \} \\ = \frac{1}{M} \{ 2 {( \frac{2 π}{M} )}^{K} {\sum }_{n = 1}^{\frac{M - 1}{2}} [ ( {n}^{K} - {( n - 1 )}^{K} ) \\ \frac{sin ( \frac{1}{2} ( \frac{M - 1}{2} + n ) ( m {θ}_{M} - {\overline{θ}}_{M} ) ) sin ( \frac{1}{2} ( \frac{M + 1}{2} - n ) ( m {θ}_{M} - {\overline{θ}}_{M} ) )}{sin \frac{1}{2} ( m {θ}_{M} - {\overline{θ}}_{M} )} ] \} ,\end{matrix}$$

$$0 \leq m \leq M - 1.$$

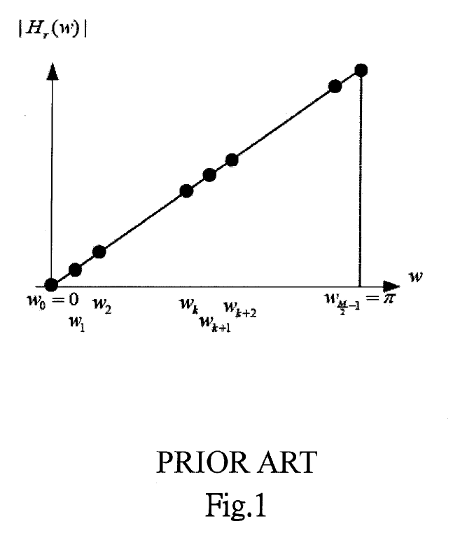

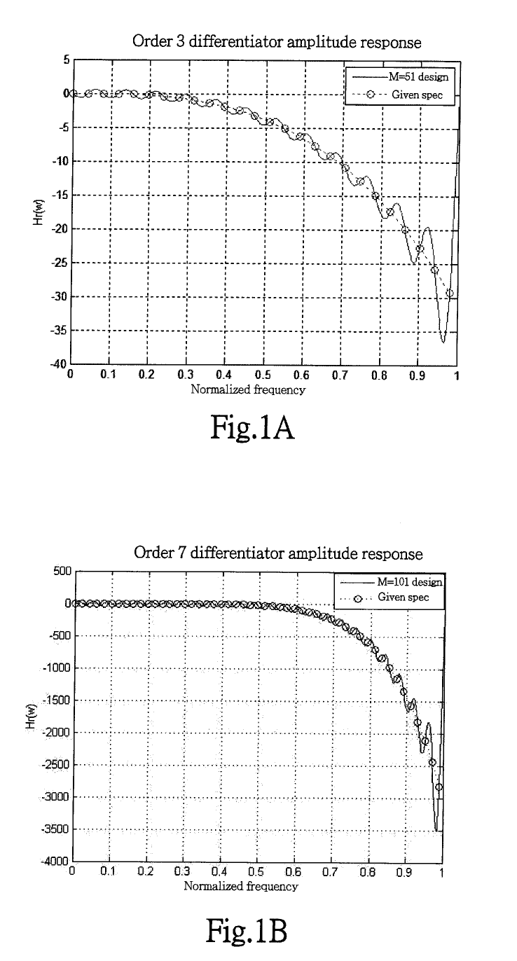

FIG. 1A is an amplitude response diagram for an all-band digital differentiator with M=51, K=3 according to the present invention. The digital differentiator resolves the problem raised by FIG. 1. As, when w=0 and w=π (i.e., the normalized frequency is 1), the frequency response function of this type of order-K digital differentiator is 0. Therefore, all-band design would have significant error at high frequencies, as can be seen from FIG. 1A as well.

The following Table 1 lists the digital signal processing system coefficients for M=51, order-3 differentiator with all-band design. If the digital signal processing system is embodied in a digital differentiator, Table 1 shows the digital differentiator coefficients.

TABLE 1

| | Coefficient by the present | |
|---|---|---|
| Filter coefficient | invention | Filter coefficient |
| h(0) | −0.607551798225166 | −h(50) |
| h(1) | 0.609854469008660 | −h(49) |
| h(2) | −0.614503545413603 | −h(48) |
| h(3) | 0.621588534444675 | −h(47) |
| h(4) | −0.631248967997969 | −h(46) |
| h(5) | 0.643681252397096 | −h(45) |
| h(6) | −0.659148755404512 | −h(44) |
| h(7) | 0.677996129394913 | −h(43) |
| h(8) | −0.700669392011971 | −h(42) |
| h(9) | 0.727744079964486 | −h(41) |
| h(10) | −0.759965039064996 | −h(40) |
| h(11) | 0.798303432210820 | −h(39) |
| h(12) | −0.844039913190771 | −h(38) |
| h(13) | 0.898888709931315 | −h(37) |
| h(14) | −0.965187695786594 | −h(36) |
| h(15) | 1.046198692736652 | −h(35) |
| h(16) | −1.146599393008319 | −h(34) |
| h(17) | 1.273323945342434 | −h(33) |
| h(18) | −1.437072223661419 | −h(32) |
| h(19) | 1.655180760114309 | −h(31) |
| h(20) | −1.957452574498282 | −h(30) |
| h(21) | 2.398775578461656 | −h(29) |
| h(22) | −3.086430801945935 | −h(28) |
| h(23) | 4.197297752378359 | −h(27) |
| h(24) | −3.875843891007819 | −h(26) |
| h(25) | 0 | h(25) |

FIG. 1B is an amplitude response diagram for an all-band digital differentiator with M=101, K=7 according to the present invention. As, when w=0 and w=π (i.e., the normalized frequency is 1), the frequency response function of this type of order-K digital differentiator is 0. Therefore, all-bend design would have significant error at high frequencies, as can be seen from FIG. 1B as well.

For even-numbered M, due to the anti-symmetric design, the following may be obtained from equation (2):

$${W}^{*} H = [ \begin{matrix}- 2 j {\sum }_{n = 1}^{\frac{M}{2} - 1} {( \frac{2 π \cdot n}{M} )}^{K} sin n {\overline{θ}}_{M} + {( \frac{2 π \cdot \frac{M}{2}}{M} )}^{K} {e}^{j \frac{M}{2} {\overline{θ}}_{M}} \\ 2 j {\sum }_{n = 1}^{\frac{M}{2} - 1} {( \frac{2 π \cdot n}{M} )}^{K} sin n ( {θ}_{M} - {\overline{θ}}_{M} ) + {( \frac{2 π \cdot \frac{M}{2}}{M} )}^{K} {e}^{j ( \frac{M}{2} {θ}_{M} + \frac{M}{2} {\overline{θ}}_{M} )} \\ 2 j {\sum }_{n = 1}^{\frac{M}{2} - 1} {( \frac{2 π \cdot n}{M} )}^{K} sin n ( 2 {θ}_{M} - {\overline{θ}}_{M} ) + {( \frac{2 π \cdot \frac{M}{2}}{M} )}^{K} {e}^{j ( \frac{M}{2} 2 {θ}_{M} + \frac{M}{2} {\overline{θ}}_{M} )} \\ ⋮ \\ 2 j {\sum }_{n = 1}^{\frac{M}{2} - 1} {( \frac{2 π \cdot n}{M} )}^{K} sin n ( ( M - 2 ) {θ}_{M} - {\overline{θ}}_{M} ) + {( \frac{\begin{matrix}2 π \cdot \\ \frac{M}{2}\end{matrix}}{M} )}^{K} {e}^{j ( \frac{M}{2} ( M - 2 ) {θ}_{M} + \frac{M}{2} {\overline{θ}}_{M} )} \\ 2 j {\sum }_{n = 1}^{\frac{M}{2} - 1} {( \frac{2 π \cdot n}{M} )}^{K} sin n ( ( M - 1 ) {θ}_{M} - {\overline{θ}}_{M} ) + {( \frac{\begin{matrix}2 π \cdot \\ \frac{M}{2}\end{matrix}}{M} )}^{K} {e}^{j ( \frac{M}{2} ( M - 1 ) {θ}_{M} + \frac{M}{2} {\overline{θ}}_{M} )}\end{matrix} ] \\ and \\ h = {[ \begin{matrix}{h}_{0} & {h}_{1} & … & {h}_{M - 1}\end{matrix} ]}^{T} = \frac{1}{M} {W}^{*} H where \\ {h}_{m} = \frac{1}{M} \{ 2 j {\sum }_{n = 1}^{\frac{M}{2} - 1} ( - j ) {( \frac{2 π \cdot n}{M} )}^{K} sin n ( m {θ}_{M} - {\overline{θ}}_{M} ) + {( \frac{2 π \cdot \frac{M}{2}}{M} )}^{K} {e}^{j ( m \frac{M}{2} {θ}_{M} + \frac{M}{2} {\overline{θ}}_{M} ) \}} = \frac{1}{M} \{ 2 {\sum }_{n = 1}^{\frac{M}{2} - 1} {( \frac{2 π \cdot n}{M} )}^{K} sin n ( m {θ}_{M} - {\overline{θ}}_{M} ) + {( \frac{2 π \cdot \frac{M}{2}}{M} )}^{K} {e}^{j \frac{2 m + M - 1}{2} π} \} = \frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{\begin{matrix}sin ( \frac{1}{2} ( \frac{M}{2} + n - 1 ) ( m {θ}_{M} - {\overline{θ}}_{M} ) ) \\ sin ( \frac{1}{2} ( \frac{M}{2} - n ) ( m {θ}_{M} - {\overline{θ}}_{M} ) )\end{matrix}}{sin \frac{1}{2} ( m {θ}_{M} - {\overline{θ}}_{M} )} ] + {( \frac{2 π \cdot \frac{M}{2}}{M} )}^{K} {e}^{j \frac{2 m + M - 1}{2} π} \} , \\ 0 \leq m \leq M - 1.$$

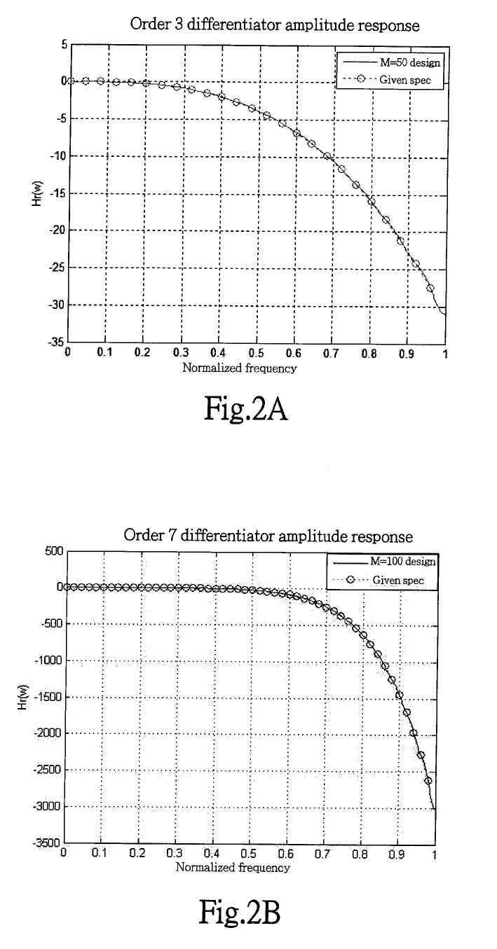

FIG. 2A is an amplitude response diagram for an all-band digital differentiator with M=50, K=3 according to the present invention. FIG. 2B is an amplitude response diagram for an all-bend digital differentiator with M=100, K=7 according to the present invention.

For odd-numbered K and

$$\frac{K - 1}{2}$$

is an even number, the frequency response function of an order-K differentiator is:

$${H}^{( K )} ( w ) = \{ \begin{matrix}{jw}^{K} , & 0 \leq w < π \\ - {jw}^{K} , & - π \leq w \leq 0\end{matrix}$$

The sampling frequency function H(m) is expressed as

$$H ( m ) = {H}_{r} ( \frac{2 π m}{M} ) {e}^{j ∠ H ( m ) }$$

$$where$$

$${H}_{r} ( \frac{2 π m}{M} ) = \{ \begin{matrix}{( \frac{2 π m}{M} )}^{K} , & m = 0 , 1 , … , ⌊ \frac{M - 1}{2} ⌋ \\ - {( \frac{2 π ( M - m )}{M} )}^{K} , & m = ⌊ \frac{M - 1}{2} ⌋ + 1 , … , M - 1\end{matrix} ,$$

and the phase angle is

$$∠ H ( m ) = \{ \begin{matrix}\frac{π}{2} - ( \frac{M - 1}{2} ) ( \frac{2 π m}{M} ) , & m = 0 , 1 , … , ⌊ \frac{M - 1}{2} ⌋ \\ - \frac{π}{2} + ( \frac{M - 1}{2} ) ( \frac{2 π ( M - m )}{M} ) , & m = ⌊ \frac{M - 1}{2} ⌋ + 1 , … , M - 1\end{matrix} ,$$

assuming that

$${H}_{m} = \{ \begin{matrix}{j ( \frac{2 π m}{M} )}^{K} , & m = 0 , 1 , … , ⌊ \frac{M - 1}{2} ⌋ \\ - {j ( \frac{2 π ( M - m )}{M} )}^{K} , & m = ⌊ \frac{M - 1}{2} ⌋ + 1 , … , M - 1\end{matrix} \\ and \\ {H}_{m} = \{ \begin{matrix}{j ( \frac{2 π m}{M} )}^{K} , & m = 0 , 1 , … , ⌊ \frac{M - 1}{2} ⌋ \\ - {j ( \frac{2 π ( M - m )}{M} )}^{K} , & m = ⌊ \frac{M - 1}{2} ⌋ + 1 , … , M - 1\end{matrix} .$$

For odd-numbered M, the all-band design may be obtained from equation (1):

$${W}^{*} H = [ \begin{matrix}- 2 j {\sum }_{n = 1}^{\frac{M - 1}{2}} {( \frac{2 π \cdot n}{M} )}^{K} sin n {\overline{θ}}_{M} \\ 2 j {\sum }_{n = 1}^{\frac{M - 1}{2}} {( \frac{2 π \cdot n}{M} )}^{K} sin n ( {θ}_{M} - {\overline{θ}}_{M} ) \\ 2 j {\sum }_{n = 1}^{\frac{M - 1}{2}} {( \frac{2 π \cdot n}{M} )}^{K} sin n ( 2 {θ}_{M} - {\overline{θ}}_{M} ) \\ ⋮ \\ 2 j {\sum }_{n = 1}^{\frac{M - 1}{2}} {( \frac{2 π \cdot n}{M} )}^{K} sin n ( ( M - 2 ) {θ}_{M} - {\overline{θ}}_{M} ) \\ 2 j {\sum }_{n = 1}^{\frac{M - 1}{2}} {( \frac{2 π \cdot n}{M} )}^{K} sin n ( ( M - 1 ) {θ}_{M} - {\overline{θ}}_{M} )\end{matrix} ] \\ and \\ h = {[ \begin{matrix}{h}_{0} & {h}_{1} & … & {h}_{M - 1}\end{matrix} ]}^{T} = \frac{1}{M} {W}^{*} H , where \\ \begin{matrix}{h}_{m} = \frac{1}{M} [ 2 {\sum }_{n = 1}^{\frac{M - 1}{2}} {( \frac{2 π \cdot n}{M} )}^{K} sin n ( m {θ}_{M} - {\overline{θ}}_{M} ) ] \\ = \frac{1}{M} [ 2 {( \frac{2 π}{M} )}^{K} {\sum }_{n = 1}^{\frac{M - 1}{2}} {n}^{K} sin n ( m {θ}_{M} - {\overline{θ}}_{M} ) ] \\ = \frac{1}{M} \{ 2 {( \frac{2 π}{M} )}^{K} {\sum }_{n = 1}^{\frac{M - 1}{2}} [ ( {n}^{K} - {( n - 1 )}^{K} ) \\ \frac{sin ( \frac{1}{2} ( \frac{M - 1}{2} + n ) ( m {θ}_{M} - {\overline{θ}}_{M} ) ) sin ( \frac{1}{2} ( \frac{M + 1}{2} - n ) ( m {θ}_{M} - {\overline{θ}}_{M} ) )}{sin \frac{1}{2} ( m {θ}_{M} - {\overline{θ}}_{M} )} ] \} ,\end{matrix} \\ 0 \leq m \leq M - 1.$$

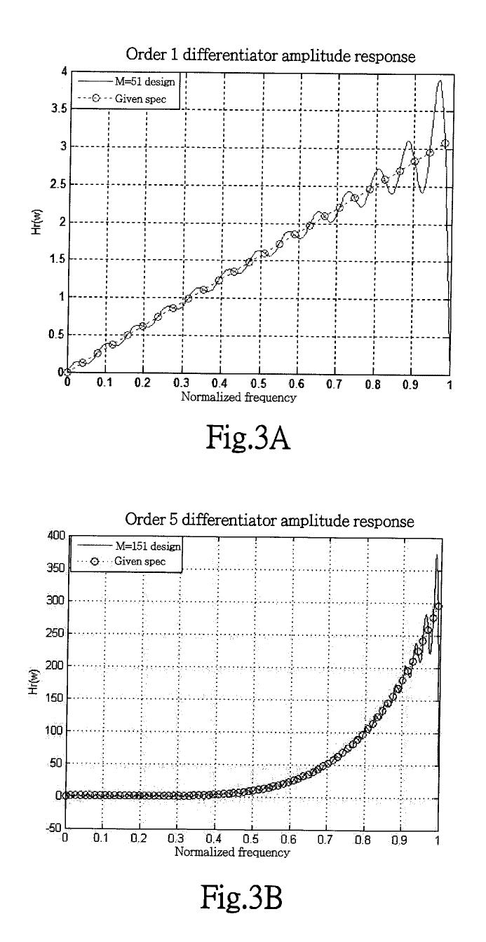

FIG. 3A is an amplitude response diagram for an all-band digital differentiator with M=51, K=1, and FIG. 3B is an amplitude response diagram for an all-band digital diffeentiator with M=151, K=5.

For even-numbered M, due to the anti-symmetric design, the following may be obtained from equation (2):

$$\begin{matrix} {W}^{⋆} H = [ \begin{matrix}- 2 j {\sum }_{n = 1}^{\frac{M}{2} - 1} {( \frac{2 π \cdot n}{M} )}^{K} sin n {\overline{θ}}_{M} + {( \frac{2 π \cdot \frac{M}{2}}{M} )}^{K} {e}^{j \frac{M}{2} {\overline{θ}}_{M}} \\ 2 j {\sum }_{n = 1}^{\frac{M}{2} - 1} {( \frac{2 π \cdot n}{M} )}^{K} sin n ( {θ}_{M} - {\overline{θ}}_{M} ) + \\ {( \frac{2 π \cdot \frac{M}{2}}{M} )}^{K} {e}^{j ( \frac{M}{2} {θ}_{M} + \frac{M}{2} {\overline{θ}}_{M} )} \\ 2 j {\sum }_{n = 1}^{\frac{M}{2} - 1} {( \frac{2 π \cdot n}{M} )}^{K} sin n ( 2 {θ}_{M} - {\overline{θ}}_{M} ) + \\ {( \frac{2 π \cdot \frac{M}{2}}{M} )}^{K} {e}^{j ( \frac{M}{2} \cdot 2 {θ}_{M} + \frac{M}{2} {\overline{θ}}_{M} )} \\ ⋮ \\ 2 j {\sum }_{n = 1}^{\frac{M}{2} - 1} {( \frac{2 π \cdot n}{M} )}^{K} sin n ( ( M - 2 ) {θ}_{M} - {\overline{θ}}_{M} ) + \\ {( \frac{2 π \cdot \frac{M}{2}}{M} )}^{K} {e}^{j ( \frac{M}{2} ( M - 2 ) {θ}_{M} + \frac{M}{2} {\overline{θ}}_{M} )} \\ 2 j {\sum }_{n = 1}^{\frac{M}{2} - 1} {( \frac{2 π \cdot n}{M} )}^{K} sin n ( ( M - 1 ) {θ}_{M} - {\overline{θ}}_{M} ) + \\ {( \frac{2 π \cdot \frac{M}{2}}{M} )}^{K} {e}^{j ( \frac{M}{2} ( M - 1 ) {θ}_{M} + \frac{M}{2} {\overline{θ}}_{M} )}\end{matrix} \\ and h = {[ {h}_{0} {h}_{1} … {h}_{M - 1} ]}^{T} = \frac{1}{M} {W}^{⋆} H , where \\ \begin{matrix}{h}_{m} = \frac{1}{M} \{ 2 j {\sum }_{n = 1}^{\frac{M}{2} - 1} {( \frac{2 π \cdot n}{M} )}^{K} sin n ( m {θ}_{m} - {\overline{θ}}_{M} ) + {( \frac{2 π \cdot \frac{M}{2}}{M} )}^{K} {e}^{j ( m \frac{M}{2} {θ}_{M} + \frac{M}{2} {\overline{θ}}_{M} )} \} = \\ \frac{1}{M} \{ 2 {j ( \frac{2 π}{M} )}^{K} {\sum }_{n = 1}^{\frac{M - 1}{2}} {n}^{K} sin n ( m {θ}_{m} - {\overline{θ}}_{M} ) + {( \frac{2 π \cdot \frac{M}{2}}{M} )}^{K} {e}^{j \frac{2 m + M - 1}{2} π} \} = \\ \frac{1}{M} [ 2 {( \frac{2 π}{M} )}^{K} {\sum }_{n = 1}^{\frac{M}{2} - 1} {n}^{K} sin n ( m {θ}_{M} - {\overline{θ}}_{M} ) + {( \frac{2 π \cdot \frac{M}{2}}{M} )}^{K} {e}^{j \frac{2 m + M - 1}{2} π} ] = \\ \frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{\begin{matrix}sin ( \frac{1}{2} ( \frac{M}{2} + n - 1 ) ( m {θ}_{M} - {\overline{θ}}_{M} ) ) \\ sin ( \frac{1}{2} ( \frac{M}{2} - n ) ( m {θ}_{M} - {\overline{θ}}_{M} ) )\end{matrix}}{sin \frac{1}{2} ( m {θ}_{M} - {\overline{θ}}_{M} )} ] + \\ {( \frac{2 π \cdot \frac{M}{2}}{M} )}^{K} {e}^{j \frac{2 m + M - 1}{2} π} \} ,\end{matrix} \\ 0 \leq m \leq M - 1.\end{matrix}$$

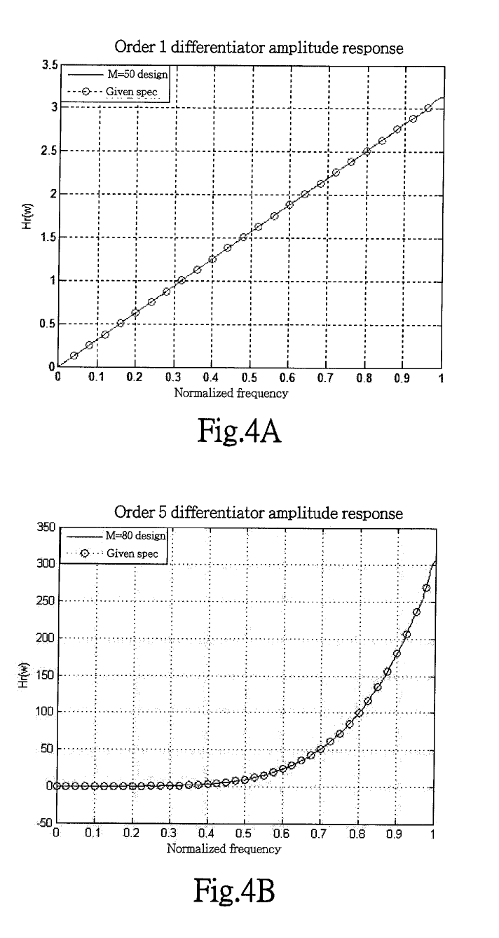

FIG. 4A is an amplitude response diagram for an all-band digital differentiator with M=50, K=1, and FIG. 4B is an amplitude response diagram for a all-band digital differentiator with M=80, K=5.

For all-band digital differentiator with even-numbered order where K is even-numbered and

$$\frac{K}{2}$$

is an odd number, the frequency response function is:

$${H}^{K} ( w ) = \{ \begin{matrix}- {w}^{K} , & 0 \leq w < π \\ - {w}^{K} , & - π \leq w \leq 0\end{matrix}$$

and the sampling frequency response function H(m) is expressed as

$$H ( m ) = {H}_{r} ( \frac{2 π m}{M} ) {e}^{j ∠ H ( m )} where {H}_{r} ( \frac{2 π m}{M} ) = \{ \begin{matrix}- {( \frac{2 π m}{M} )}^{K} , & m = 0 , 1 , ⋯ , ⌊ \frac{M - 1}{2} ⌋ \\ - {( \frac{2 π ( M - m )}{M} )}^{K} , & m = ⌊ \frac{M - 1}{2} ⌋ + 1 , ⋯ , M - 1\end{matrix} ,$$

and the phase angle is

$$∠ H ( m ) = \{ \begin{matrix}- ( \frac{M - 1}{2} ) ( \frac{2 π m}{M} ) , & m = 0 , 1 , ⋯ , ⌊ \frac{M - 1}{2} ⌋ \\ ( \frac{M - 1}{2} ) ( \frac{2 π ( M - m )}{M} ) , & m = ⌊ \frac{M - 1}{2} ⌋ + 1 , ⋯ , M - 1\end{matrix} ,$$

assuming that

$${H}_{m} = \{ \begin{matrix}- {( \frac{2 π m}{M} )}^{K} , & m = 0 , 1 , ⋯ , ⌊ \frac{M - 1}{2} ⌋ \\ - {( \frac{2 π ( M - m )}{M} )}^{K} , & m = ⌊ \frac{M - 1}{2} ⌋ + 1 , ⋯ , M - 1\end{matrix} , and {∠H}_{m} = \{ \begin{matrix}- ( \frac{M - 1}{2} ) ( \frac{2 π m}{M} ) , & m = 0 , 1 , ⋯ , ⌊ \frac{M - 1}{2} ⌋ \\ ( \frac{( M - 1 )}{M} ) ( \frac{2 π ( M - m )}{M} ) , & m = ⌊ \frac{M - 1}{2} ⌋ + 1 , ⋯ , M - 1\end{matrix} .$$

For odd-numbered M, due to the symmetric design, the following may be obtained from equation (1):

$$\begin{matrix} {W}^{⋆} H = [ \begin{matrix}2 {\sum }_{n = 1}^{\frac{M - 1}{2}} {( \frac{2 π \cdot n}{M} )}^{K} cos n {\overline{θ}}_{M} \\ 2 {\sum }_{n = 1}^{\frac{M - 1}{2}} {( \frac{2 π \cdot n}{M} )}^{K} cos n ( {θ}_{M} - {\overline{θ}}_{M} ) \\ 2 {\sum }_{n = 1}^{\frac{M - 1}{2}} {( \frac{2 π \cdot n}{M} )}^{K} cos n ( 2 {θ}_{M} - {\overline{θ}}_{M} ) \\ ⋮ \\ 2 {\sum }_{n = 1}^{\frac{M - 1}{2}} {( \frac{2 π \cdot n}{M} )}^{K} cos n ( ( M - 2 ) {θ}_{M} - {\overline{θ}}_{M} ) \\ 2 {\sum }_{k = 1}^{\frac{M - 1}{2}} {( \frac{2 π \cdot n}{M} )}^{K} cos k ( ( M - 1 ) {θ}_{M} - {\overline{θ}}_{M} )\end{matrix} ] \\ and \\ h = {[ {h}_{0} {h}_{1} ⋯ {h}_{M - 1} ]}^{T} = \frac{1}{M} {W}^{⋆} H \\ where \\ \begin{matrix}{h}_{m} = \frac{1}{M} [ 2 {\sum }_{k = 1}^{\frac{M - 1}{2}} {( \frac{2 π \cdot n}{M} )}^{K} cos k ( m {θ}_{m} - {\overline{θ}}_{M} ) ] = \\ \frac{1}{M} [ 2 {( \frac{2 π}{M} )}^{K} {\sum }_{k = 1}^{\frac{M - 1}{2}} {n}^{K} cos k ( m {θ}_{m} - {\overline{θ}}_{M} ) ] = \\ \frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{\begin{matrix}cos ( \frac{1}{2} ( \frac{M - 1}{2} + n ) ( m {θ}_{M} - {\overline{θ}}_{M} ) ) \\ sin ( \frac{1}{2} ( \frac{M + 1}{2} - n ) ( m {θ}_{M} - {\overline{θ}}_{M} ) )\end{matrix}}{sin \frac{1}{2} ( m {θ}_{M} - {\overline{θ}}_{M} )} ] \} ,\end{matrix} \\ 0 \leq m \leq M - 1.\end{matrix}$$

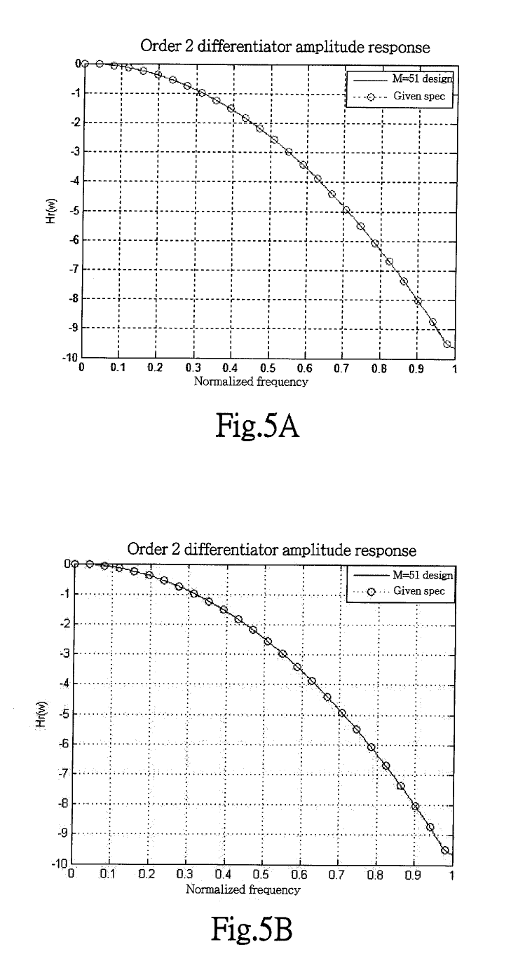

FIG. 5A is an amplitude response diagram for an all-band digital differntiator with M=51, K=2, and FIG. 5B is an amplitude response diagram for an all-band digital differentiator with M=85, K=6.

For even-numbered M, due to the symmetric design, the following may be obtained from equation (2):

$$\begin{matrix} {W}^{⋆} H = [ \begin{matrix}2 {\sum }_{n = 1}^{\frac{M}{2} - 1} {( \frac{2 π \cdot n}{M} )}^{K} cos n {\overline{θ}}_{M} + {( \frac{2 π \cdot \frac{M}{2}}{M} )}^{K} {e}^{j \frac{M}{2} {\overline{θ}}_{M}} \\ 2 {\sum }_{n = 1}^{\frac{M}{2} - 1} {( \frac{2 π \cdot n}{M} )}^{K} cos n ( {θ}_{M} - {\overline{θ}}_{M} ) + \\ {( \frac{2 π \cdot \frac{M}{2}}{M} )}^{K} {e}^{j ( \frac{M}{2} {θ}_{M} + \frac{M}{2} {\overline{θ}}_{M} )} \\ 2 {\sum }_{n = 1}^{\frac{M}{2} - 1} {( \frac{2 π \cdot n}{M} )}^{K} cos n ( 2 {θ}_{M} - {\overline{θ}}_{M} ) + \\ {( \frac{2 π \cdot \frac{M}{2}}{M} )}^{K} {e}^{j ( \frac{M}{2} \cdot 2 {θ}_{M} + \frac{M}{2} {\overline{θ}}_{M} )} \\ ⋮ \\ 2 {\sum }_{n = 1}^{\frac{M}{2} - 1} {( \frac{2 π \cdot n}{M} )}^{K} cos n ( ( M - 2 ) {θ}_{M} - {\overline{θ}}_{M} ) + \\ {( \frac{2 π \cdot \frac{M}{2}}{M} )}^{K} {e}^{j ( \frac{M}{2} ( M - 2 ) {θ}_{M} + \frac{M}{2} {\overline{θ}}_{M} )} \\ 2 {\sum }_{n = 1}^{\frac{M}{2} - 1} {( \frac{2 π \cdot n}{M} )}^{K} cos n ( ( M - 1 ) {θ}_{M} - {\overline{θ}}_{M} ) + \\ {( \frac{2 π \cdot \frac{M}{2}}{M} )}^{K} {e}^{j ( \frac{M}{2} ( M - 1 ) {θ}_{M} + \frac{M}{2} {\overline{θ}}_{M} )}\end{matrix} ] \\ and h = {[ {h}_{0} {h}_{1} ⋯ {h}_{M - 1} ]}^{T} = \frac{1}{M} {W}^{⋆} H , where \\ \begin{matrix}{h}_{m} = \frac{1}{M} [ 2 {\sum }_{n = 1}^{\frac{M}{2} - 1} {( \frac{2 π \cdot n}{M} )}^{K} cos n ( m {θ}_{m} - {\overline{θ}}_{M} ) + {( \frac{2 π \cdot \frac{M}{2}}{M} )}^{K} {e}^{j ( m \frac{M}{2} {θ}_{M} + \frac{M}{2} {\overline{θ}}_{M} )} ] = \\ \frac{1}{M} [ 2 {( \frac{2 π}{M} )}^{K} {\sum }_{n = 1}^{\frac{M}{2} - 1} {n}^{K} cos n ( m {θ}_{m} - {\overline{θ}}_{M} ) + {( \frac{2 π \cdot \frac{M}{2}}{M} )}^{K} {e}^{j ( m + \frac{M - 1}{2} ) π} ] = \\ \frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{\begin{matrix}cos ( \frac{1}{2} ( \frac{M}{2} - 1 + n ) ( m {θ}_{M} - {\overline{θ}}_{M} ) ) \\ sin ( \frac{1}{2} ( \frac{M}{2} - n ) ( m {θ}_{M} - {\overline{θ}}_{M} ) )\end{matrix}}{sin \frac{1}{2} ( m {θ}_{M} - {\overline{θ}}_{M} )} ] + \\ {( \frac{2 π \cdot \frac{M}{2}}{M} )}^{K} {e}^{j ( m \frac{M}{2} {θ}_{M} + \frac{M}{2} {\overline{θ}}_{M} )} \}\end{matrix}\end{matrix}$$

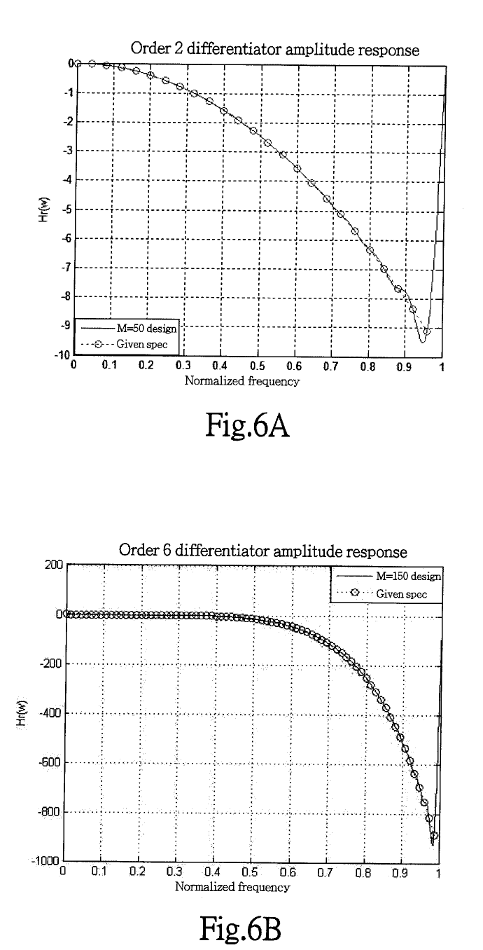

FIG. 6A is an amplitude response diagram for an all-band digital differentiator with M=50, K=2, and FIG. 6B is an amplitude response diagram for an all-band digital differentiator with M=150, K=6.

For even-numbered K and

$$\frac{K}{2}$$

is an even number, the frequency response function of an order-K differentiator is:

$${H}^{( K )} ( w ) = \{ \begin{matrix}{jw}^{K} , & 0 \leq w < π \\ - {jw}^{K} , & - π \leq w \leq 0\end{matrix} ,$$

the sampling frequency response function H(m) is expressed as

$$H ( m ) = {H}_{r} ( \frac{2 π m}{M} ) {e}^{j∠H ( m )} , where {H}_{r} ( \frac{2 π m}{M} ) = \{ \begin{matrix}{( \frac{2 π m}{M} )}^{K} , & m = 0 , 1 , ⋯ , ⌊ \frac{M - 1}{2} ⌋ \\ - {( \frac{2 π ( M - m )}{M} )}^{K} , & m = ⌊ \frac{M - 1}{2} ⌋ + 1 , ⋯ , M - 1\end{matrix} ,$$

the phase angle is

$$∠H ( m ) = \{ \begin{matrix}\frac{π}{2} - ( \frac{M - 1}{2} ) ( \frac{2 π m}{M} ) , & m = 0 , 1 , ⋯ , ⌊ \frac{M - 1}{2} ⌋ \\ - \frac{π}{2} + ( \frac{M - 1}{M} ) ( \frac{2 π ( M - m )}{M} ) , & m = ⌊ \frac{M - 1}{2} ⌋ + 1 , ⋯ , M - 1\end{matrix} ,$$

assuming that

$${H}_{m} = \{ \begin{matrix}{j ( \frac{2 π m}{M} )}^{K} , & m = 0 , 1 , ⋯ , ⌊ \frac{M - 1}{2} ⌋ \\ - {j ( \frac{2 πM - m}{M} )}^{K} , & m = ⌊ \frac{M - 1}{2} ⌋ + 1 , ⋯ , M - 1\end{matrix} , and {∠H}_{m} = \{ \begin{matrix}- ( \frac{M - 1}{2} ) ( \frac{2 π m}{M} ) , & m = 0 , 1 , ⋯ , ⌊ \frac{M - 1}{2} ⌋ \\ ( \frac{M - 1}{M} ) ( \frac{2 π ( M - m )}{M} ) , & m = ⌊ \frac{M - 1}{2} ⌋ + 1 , ⋯ , M - 1\end{matrix} .$$

For odd-numbered M, due to the symmetric design, the following may be obtained from equation (1):

$$\begin{matrix} {W}^{⋆} H = [ \begin{matrix}2 {\sum }_{n = 1}^{\frac{M - 1}{2}} {( \frac{2 π \cdot n}{M} )}^{K} cos n {\overline{θ}}_{M} ) \\ 2 {\sum }_{n = 1}^{\frac{M - 1}{2}} {( \frac{2 π \cdot n}{M} )}^{K} cos n ( {θ}_{M} - {\overline{θ}}_{M} ) \\ 2 {\sum }_{n = 1}^{\frac{M - 1}{2}} {( \frac{2 π \cdot n}{M} )}^{K} cos n ( 2 {θ}_{M} - {\overline{θ}}_{M} ) \\ ⋮ \\ 2 {\sum }_{n = 1}^{\frac{M - 1}{2}} {( \frac{2 π \cdot n}{M} )}^{K} cos n ( ( M - 2 ) {θ}_{M} - {\overline{θ}}_{M} ) \\ 2 {\sum }_{k = 1}^{\frac{M - 1}{2}} {( \frac{2 π \cdot n}{M} )}^{K} cos k ( ( M - 1 ) {θ}_{M} - {\overline{θ}}_{M} )\end{matrix} ] \\ and \\ h = {[ {h}_{0} {h}_{1} ⋯ {h}_{M - 1} ]}^{T} = \frac{1}{M} {W}^{⋆} H \\ where \\ \begin{matrix}{h}_{m} = \frac{1}{M} [ 2 {\sum }_{k = 1}^{\frac{M - 1}{2}} {( \frac{2 π \cdot n}{M} )}^{K} cos k ( m {θ}_{m} - {\overline{θ}}_{M} ) ] = \\ \frac{1}{M} [ 2 {( \frac{2 π}{M} )}^{K} {\sum }_{k = 1}^{\frac{M - 1}{2}} {n}^{K} cos k ( m {θ}_{m} - {\overline{θ}}_{M} ) ] = \\ \frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{\begin{matrix}cos ( \frac{1}{2} ( \frac{M - 1}{2} + n ) ( m {θ}_{M} - {\overline{θ}}_{M} ) ) \\ sin ( \frac{1}{2} ( \frac{M + 1}{2} - n ) ( m {θ}_{M} - {\overline{θ}}_{M} ) )\end{matrix}}{sin \frac{1}{2} ( m {θ}_{M} - {\overline{θ}}_{M} )} ] \} , \\ 0 \leq m \leq M - 1.\end{matrix}\end{matrix}$$

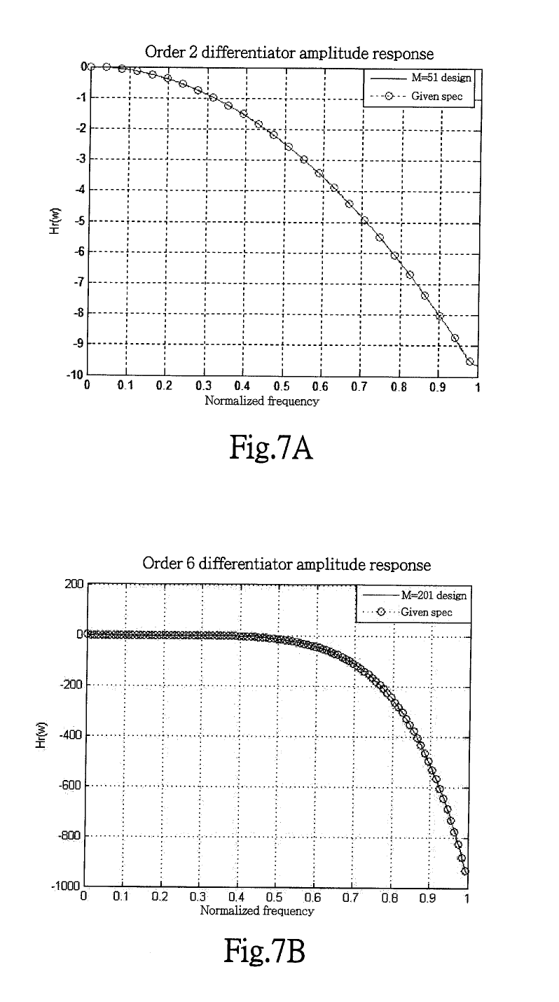

FIG. 7A is an amplitude response diagram for an all-band digital differentiator with M=51, K=2, and FIG. 7B is an amplitude response diagram for an all-band digital differentiator with M=201, K=6.

For even-numbered M, due to the anti-symmetric design, the following may be obtained from equation (2):

$$\begin{matrix} {W}^{⋆} H = [ \begin{matrix}2 {\sum }_{n = 1}^{\frac{M}{2} - 1} {( \frac{2 π \cdot n}{M} )}^{K} cos n {\overline{θ}}_{M} + {( \frac{2 π \cdot \frac{M}{2}}{M} )}^{K} {e}^{j \frac{M}{2} {\overline{θ}}_{M}} \\ 2 {\sum }_{n = 1}^{\frac{M}{2} - 1} {( \frac{2 π \cdot n}{M} )}^{K} cos n ( {θ}_{M} - {\overline{θ}}_{M} ) + \\ {( \frac{2 π \cdot \frac{M}{2}}{M} )}^{K} {e}^{j ( \frac{M}{2} {θ}_{M} + \frac{M}{2} \cdot {\overline{θ}}_{M} )} \\ 2 {\sum }_{n = 1}^{\frac{M}{2} - 1} {( \frac{2 π \cdot n}{M} )}^{K} cos n ( 2 {θ}_{M} - {\overline{θ}}_{M} ) + \\ {( \frac{2 π \cdot \frac{M}{2}}{M} )}^{K} {e}^{j ( \frac{M}{2} \cdot 2 {θ}_{M} + \frac{M}{2} {\overline{θ}}_{M} )} \\ ⋮ \\ 2 {\sum }_{n = 1}^{\frac{M}{2} - 1} {( \frac{2 π \cdot n}{M} )}^{K} cos n ( ( M - 2 ) {θ}_{M} - {\overline{θ}}_{M} ) + \\ {( \frac{2 π \cdot \frac{M}{2}}{M} )}^{K} {e}^{j ( \frac{M}{2} ( M - 2 ) {θ}_{M} + \frac{M}{2} {\overline{θ}}_{M} )} \\ 2 {\sum }_{n = 1}^{\frac{M}{2} - 1} {( \frac{2 π \cdot n}{M} )}^{K} cos n ( ( M - 1 ) {θ}_{M} - {\overline{θ}}_{M} ) + \\ {( \frac{2 π \cdot \frac{M}{2}}{M} )}^{K} {e}^{j ( \frac{M}{2} ( M - 1 ) {θ}_{M} + \frac{M}{2} {\overline{θ}}_{M} )}\end{matrix} ] \\ and h = {[ {h}_{0} {h}_{1} ⋯ {h}_{M - 1} \}}^{T} = \frac{1}{M} {W}^{⋆} H , where \\ \begin{matrix}{h}_{m} = \frac{1}{M} [ 2 {\sum }_{n = 1}^{\frac{M}{2} - 1} {( \frac{2 π \cdot n}{M} )}^{K} cos n ( m {θ}_{m} - {\overline{θ}}_{M} ) + {( \frac{2 π \cdot \frac{M}{2}}{M} )}^{K} {e}^{j ( m \frac{M}{2} {θ}_{M} + \frac{M}{2} {\overline{θ}}_{M} )} ] = \\ \frac{1}{M} [ 2 {( \frac{2 π}{M} )}^{K} {\sum }_{n = 1}^{\frac{M}{2} - 1} {n}^{K} cos n ( m {θ}_{m} - {\overline{θ}}_{M} ) + {( \frac{2 π \cdot \frac{M}{2}}{M} )}^{K} {e}^{j ( m + \frac{M - 1}{2} ) π} ] = \\ \frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{\begin{matrix}cos ( \frac{1}{2} ( \frac{M}{2} - 1 + n ) ( m {θ}_{M} - {\overline{θ}}_{M} ) ) \\ sin ( \frac{1}{2} ( \frac{M}{2} - n ) ( m {θ}_{M} - {\overline{θ}}_{M} ) )\end{matrix}}{sin \frac{1}{2} ( m {θ}_{M} - {\overline{θ}}_{M} )} ] + \\ {( \frac{2 π \cdot \frac{M}{2}}{M} )}^{K} {e}^{j ( m \frac{M}{2} {θ}_{M} + \frac{M}{2} {\overline{θ}}_{M} )} \}\end{matrix}\end{matrix}$$

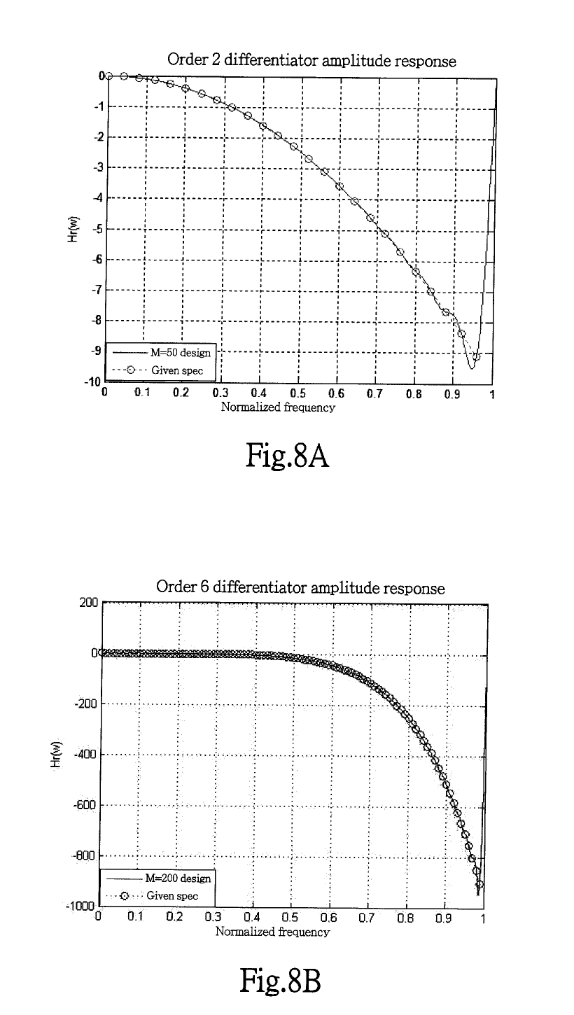

FIG. 8A is an amplitude response diagram for an all-band digital diffeentiator with M=50, K=2, and FIG. 8B is an amplitude response diagram for an all-band digital differentiator with M=200, K=6.

The following is a design method for a partial-bend digital differentiator. For partial-band design, it is assumed that

$${N}_{1} < ⌊ \frac{M - 1}{2} ⌋ .$$

The design specification is:

$${H}_{m} = \{ \begin{matrix}- {j ( \frac{2 π m}{M} )}^{K} , & m = 0 , 1 , … , {N}_{1} \\ 0 , & \\ {j ( \frac{2 π ( M - m )}{M} )}^{K} , & m = {N}_{1} + 1 , … , M - 1\end{matrix} , and \\ {∠H}_{m} = \{ \begin{matrix}- ( \frac{M - 1}{2} ) ( \frac{2 π m}{M} ) , & m = 0 , 1 , … , ⌊ \frac{M - 1}{2} ⌋ \\ 0 , & \\ ( \frac{M - 1}{2} ) ( \frac{2 π ( M - m )}{M} ) , & m = ⌊ \frac{M - 1}{2} ⌋ + 1 , … , M - 1\end{matrix} .$$

For the design of a partial-band differentiator with an odd-numbered order, the following may be obtained from equation (1) when K is an odd number:

$${W}^{*} H = [ \begin{matrix}- 2 j {\sum }_{n = 1}^{{N}_{1}} {( \frac{2 π \cdot n}{M} )}^{K} sin n {\overline{θ}}_{M} ) \\ 2 j {\sum }_{n = 1}^{{N}_{1}} {( \frac{2 π \cdot n}{M} )}^{K} sin n ( {θ}_{M} - {\overline{θ}}_{M} ) \\ 2 j {\sum }_{n = 1}^{{N}_{1}} {( \frac{2 π \cdot n}{M} )}^{K} sin n ( 2 {θ}_{M} - {\overline{θ}}_{M} ) \\ ⋮ \\ 2 j {\sum }_{n = 1}^{{N}_{1}} {( \frac{2 π \cdot n}{M} )}^{K} sin n ( ( M - 2 ) {θ}_{M} - {\overline{θ}}_{M} ) \\ 2 j {\sum }_{n = 1}^{{N}_{1}} {( \frac{2 π \cdot n}{M} )}^{K} sin n ( ( M - 1 ) {θ}_{M} - {\overline{θ}}_{M} )\end{matrix} ]$$

$$and h = {[ \begin{matrix}{h}_{0} & {h}_{1} & … & {h}_{M - 1}\end{matrix} ]}^{T} = \frac{1}{M} {W}^{*} H . Therefore , \\ \begin{matrix}{h}_{m} = \frac{1}{M} [ 2 j {\sum }_{n = 1}^{{N}_{1}} ( - j ) {( \frac{2 π \cdot n}{M} )}^{K} sin n ( m {θ}_{M} - {\overline{θ}}_{M} ) ] \\ = \frac{1}{M} [ 2 {( \frac{2 π}{M} )}^{K} {\sum }_{n = 1}^{{N}_{1}} {n}^{K} sin n ( m {θ}_{M} - {\overline{θ}}_{M} ) ] \\ = \frac{1}{M} \{ 2 {( \frac{2 π}{M} )}^{K} {\sum }_{n = 1}^{{N}_{1}} [ ( {n}^{K} - {( n - 1 )}^{K} ) {\sum }_{m = n}^{{N}_{1}} sin m ( m {θ}_{M} - {\overline{θ}}_{M} ) ] \} \\ = \frac{1}{M} \{ 2 {( \frac{2 π}{M} )}^{K} {\sum }_{n = 1}^{{N}_{1}} [ ( {n}^{K} - {( n - 1 )}^{K} ) \\ \frac{sin ( \frac{1}{2} ( {N}_{1} + n ) ( m {θ}_{M} - {\overline{θ}}_{M} ) ) sin ( \frac{1}{2} ( {N}_{1} - n + 1 ) ( m {θ}_{M} - {\overline{θ}}_{M} ) )}{sin \frac{1}{2} ( m {θ}_{M} - {\overline{θ}}_{M} )} ] \} ,\end{matrix}$$

$$0 \leq m \leq M - 1.$$

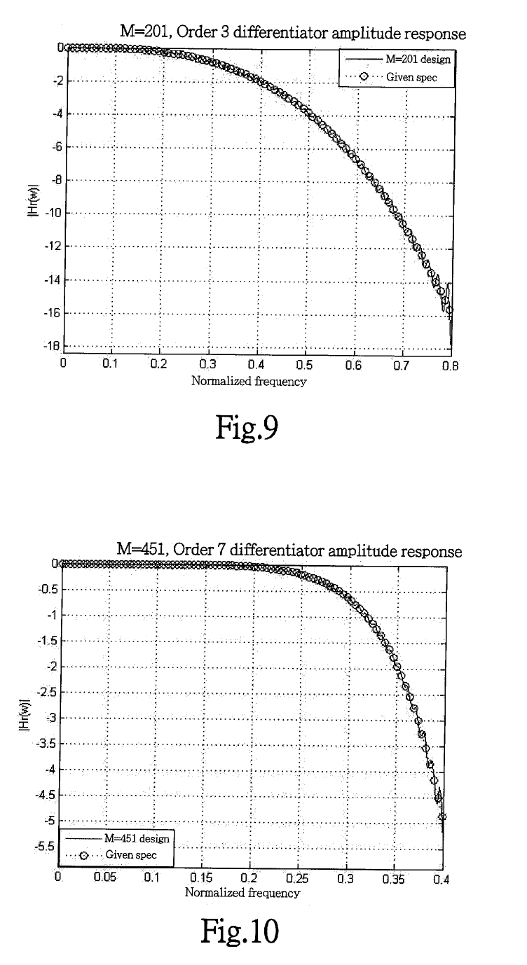

FIG. 9 is an amplitude response diagram for a partial-band digital differentiator with M=201, N₁=81, K=3, and FIG. 10 is an amplitude response diagram for a partial-band digital differentiator with M=451, N₁=91, K=7.

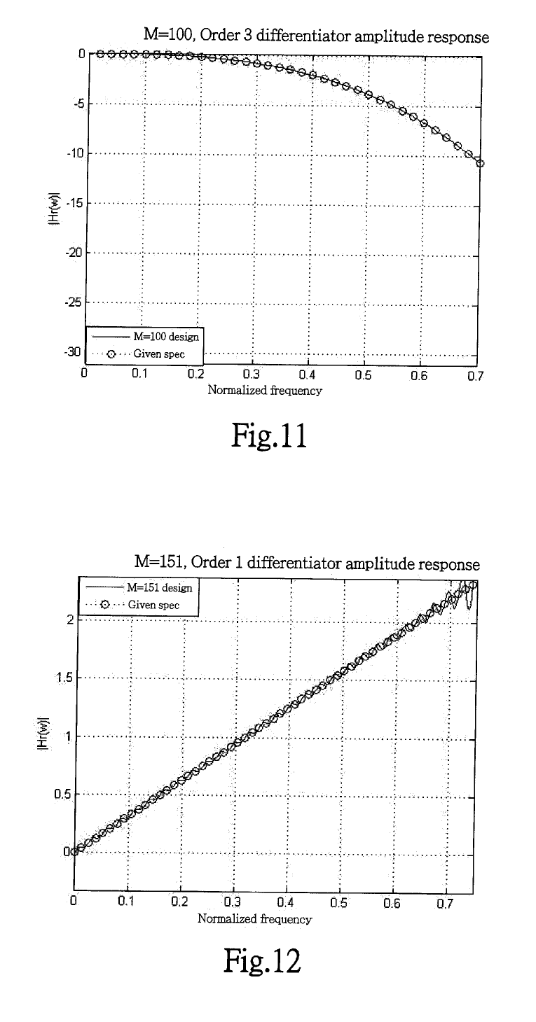

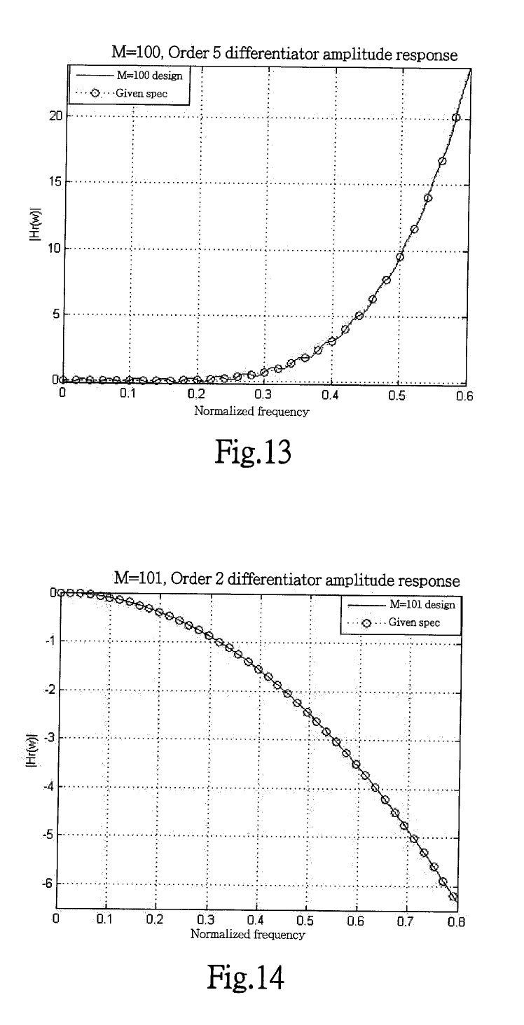

FIG. 11 is an amplitude response diagram for a partial-band digital differentiator with M=100, =N₁ 35, K=3, FIG. 12 is an amplitude response diagram for a partial-band digital differentiator with M=151, N₁=57, K=1, and FIG. 13 is an amplitude response diagram for a partial-band digital differentiator with M=100, N₁=30, K=5.

For the design of a partial-band differentiator with an even-numbered order, the following may be obtained from equation (2) when K is an even number.

$${W}^{*} H = [ \begin{matrix}2 {\sum }_{n = 1}^{{N}_{1}} {( \frac{2 π \cdot n}{M} )}^{K} cos n {\overline{θ}}_{M} ) \\ 2 {\sum }_{n = 1}^{{N}_{1}} {( \frac{2 π \cdot n}{M} )}^{K} cos n ( {θ}_{M} - {\overline{θ}}_{M} ) \\ 2 {\sum }_{n = 1}^{{N}_{1}} {( \frac{2 π \cdot n}{M} )}^{K} cos n ( 2 {θ}_{M} - {\overline{θ}}_{M} ) \\ ⋮ \\ 2 {\sum }_{n = 1}^{{N}_{1}} {( \frac{2 π \cdot n}{M} )}^{K} cos n ( ( M - 2 ) {θ}_{M} - {\overline{θ}}_{M} ) \\ 2 {\sum }_{n = 1}^{{N}_{1}} {( \frac{2 π \cdot n}{M} )}^{K} cos n ( ( M - 1 ) {θ}_{M} - {\overline{θ}}_{M} )\end{matrix} ]$$

$$and h = {[ \begin{matrix}{h}_{0} & {h}_{1} & … & {h}_{M - 1}\end{matrix} ]}^{T} = \frac{1}{M} {W}^{*} H , therefore$$

$$\begin{matrix}{h}_{m} = \frac{1}{M} [ 2 {\sum }_{n = 1}^{{N}_{1}} {( \frac{2 π \cdot n}{M} )}^{K} cos n ( m {θ}_{M} - {\overline{θ}}_{M} ) ] \\ = \frac{1}{M} [ 2 {( \frac{2 π}{M} )}^{K} {\sum }_{n = 1}^{{N}_{1}} {n}^{K} cos n ( m {θ}_{M} - {\overline{θ}}_{M} ) ] \\ = \frac{1}{M} \{ 2 {( \frac{2 π}{M} )}^{K} {\sum }_{n = 1}^{{N}_{1}} [ ( {n}^{K} - {( n - 1 )}^{K} ) {\sum }_{m = n}^{{N}_{1}} cos m ( m {θ}_{M} - {\overline{θ}}_{M} ) ] \} \\ = \frac{1}{M} \{ 2 {( \frac{2 π}{M} )}^{K} {\sum }_{n = 1}^{{N}_{1}} [ ( {n}^{K} - {( n - 1 )}^{K} ) \\ \frac{cos ( \frac{1}{2} ( {N}_{1} + n ) ( m {θ}_{M} - {\overline{θ}}_{M} ) ) sin ( \frac{1}{2} ( {N}_{1} - n + 1 ) ( m {θ}_{M} - {\overline{θ}}_{M} ) )}{sin \frac{1}{2} ( m {θ}_{M} - {\overline{θ}}_{M} )} ] \} ,\end{matrix}$$

$$0 \leq m \leq M - 1.$$

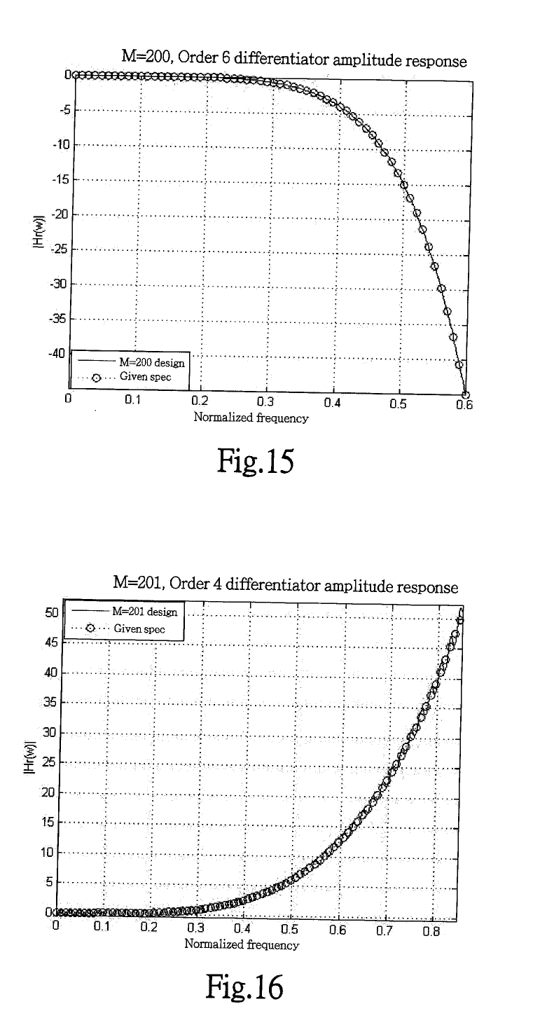

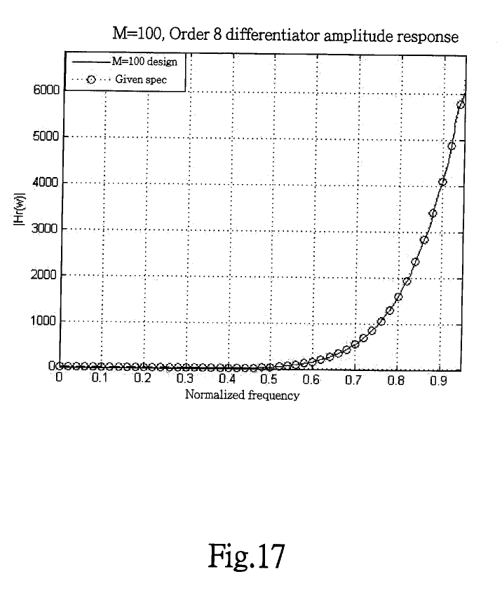

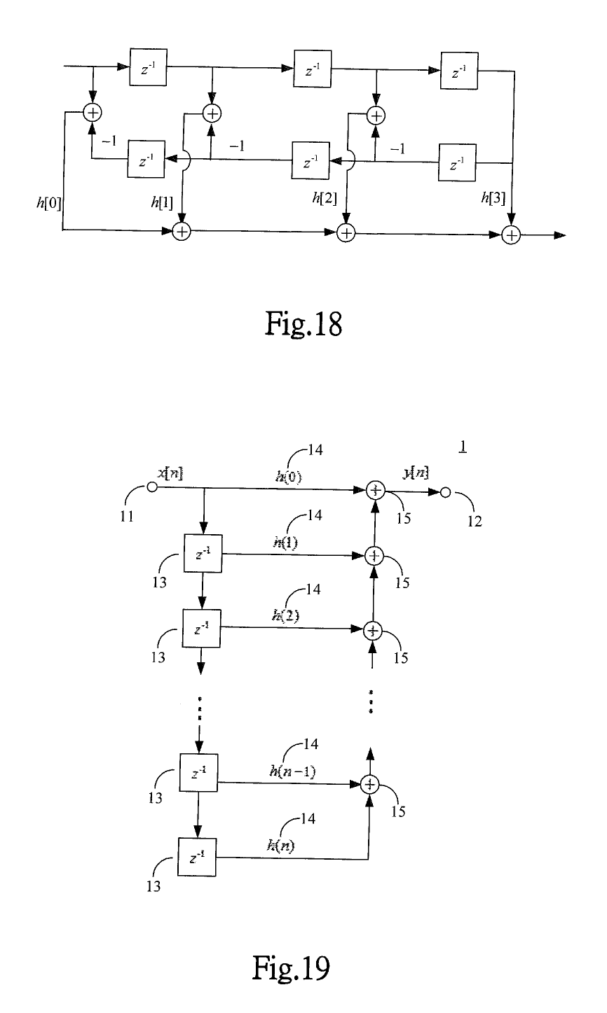

FIG. 14 is an amplitude response diagram for a partial-band digital differentiator with M=101, N₁=41, K=2, FIG. 15 is an amplitude response diagram for a partial-band digital differentiator with M=200, N₁=60, K=6, FIG. 16 is an amplitude response diagram for a partial-band digital differentiator with M=201, N₁=86, K=4, and FIG. 7 is an amplitude response diagram for a partial-band digital differentiator with M=100, N₁=48, K=8.

The following table is the frequency response functions and frequency response coefficients for all-band design according to the present invention.

The all-band design reference table:

| | |
|---|---|
| Ideal freq. response | Design method |
| H^{(K)}(w) | hₘ, 0 ≤ m ≤ M − 1 |

$K is odd \text{-} numbered , \frac{K - 1}{2} is odd \text{-} numbered$

| | | |
|---|---|---|
| M is odd- num- bered | $\{ \begin{matrix}- {jw}^{K} , & 0 \leq w < π \\ {jw}^{K} , & - π \leq w \leq 0\end{matrix}$ | $\frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{cos ( ( n - \frac{1}{2} ) ( m {θ}_{M} - {\overline{θ}}_{M} ) ) - cos ( \frac{M}{2} ( m {θ}_{M} - {\overline{θ}}_{M} ) )}{2 sin \frac{1}{2} ( m {θ}_{M} - {\overline{θ}}_{M} )} ] \}$ |
| M is even- num- bered | $\{ \begin{matrix}- {jw}^{K} , & 0 \leq w < π \\ {jw}^{K} , & - π \leq w \leq 0\end{matrix}$ | $\frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{cos ( ( n - \frac{1}{2} ) ( m {θ}_{M} - {\overline{θ}}_{M} ) ) - cos ( ( \frac{M}{2} - \frac{1}{2} ) ( m {θ}_{M} - {\overline{θ}}_{M} ) )}{2 sin \frac{1}{2} ( m {θ}_{M} - {\overline{θ}}_{M} )} ] + {( \frac{2 π \frac{M}{2}}{M} )}^{K} {e}^{j \frac{2 m + M - 1}{2} π} \}$ |

$K is odd \text{-} numbered , \frac{K - 1}{2} is even \text{-} numbered$

| | | |
|---|---|---|
| M is odd- num- bered | $\{ \begin{matrix}{jw}^{K} , & 0 \leq w < π \\ - {jw}^{K} , & - π \leq w \leq 0\end{matrix}$ | $\frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{cos ( ( n - \frac{1}{2} ) ( m {θ}_{M} - {\overline{θ}}_{M} ) ) - cos ( \frac{M}{2} ( m {θ}_{M} - {\overline{θ}}_{M} ) )}{2 sin \frac{1}{2} ( m {θ}_{M} - {\overline{θ}}_{M} )} ] \}$ |
| M is even- num- bered | $\{ \begin{matrix}{jw}^{K} , & 0 \leq w < π \\ - {jw}^{K} , & - π \leq w \leq 0\end{matrix}$ | $\frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{cos ( ( n - \frac{1}{2} ) ( m {θ}_{M} - {\overline{θ}}_{M} ) ) - cos ( ( \frac{M}{2} - \frac{1}{2} ) ( m {θ}_{M} - {\overline{θ}}_{M} ) )}{2 sin \frac{1}{2} ( m {θ}_{M} - {\overline{θ}}_{M} )} ] + {( \frac{2 π \frac{M}{2}}{M} )}^{K} {e}^{j \frac{2 m + M - 1}{2} π} \}$ |

$K is even \text{-} numbered , \frac{K}{2} is odd \text{-} numbered$

| | | |
|---|---|---|
| M is odd- num- bered | −w^{K}, −π ≤ w < π | $\frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{sin ( \frac{M}{2} ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} ] \}$ |
| M is even- num- bered | −w^{K}, −π ≤ w < π | $\frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{sin ( \frac{M}{2} - \frac{1}{2} ) ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} ] + {( \frac{2 π \frac{M}{2}}{M} )}^{K} {e}^{j ( m \frac{M}{2} {θ}_{M} + \frac{M}{2} {\overline{θ}}_{M} )} \}$ |

$K is even \text{-} numbered , \frac{K}{2} is even \text{-} numbered$

| | | |
|---|---|---|
| M is odd- num- bered | $\{ \begin{matrix}{jw}^{K} , & 0 \leq w < π \\ - {jw}^{K} , & - π \leq w \leq 0\end{matrix}$ | $\frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{sin ( \frac{M}{2} ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} ] \}$ |
| M is even- num- bered | $\{ \begin{matrix}{jw}^{K} , & 0 \leq w < π \\ - {jw}^{K} , & - π \leq w \leq 0\end{matrix}$ | $\frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{sin ( \frac{M}{2} - \frac{1}{2} ) ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} ] + {( \frac{2 π \frac{M}{2}}{M} )}^{K} {e}^{j ( m \frac{M}{2} {θ}_{M} + \frac{M}{2} {\overline{θ}}_{M} )} \}$ |

The partial-band design reference table, assuming

$${N}_{1} < ⌊ \frac{M - 1}{2} ⌋ :$$

| | |
|---|---|
| $\begin{matrix}Frequency response \\ {H}_{m} \{ \begin{matrix}- {j ( \frac{2 π m}{M} )}^{K} , & m = 0 , 1 , … , {N}_{1} \\ 0 , & \\ {j ( \frac{2 π ( M - m )}{M} )}^{K} , & m = {N}_{1} + 1 , … , M - 1\end{matrix}\end{matrix}$ | Design method hₘ, 0 ≤ m ≤ M − 1 |

$K is odd \text{-} numbered , {h}_{m} = \frac{1}{M} \{ 2 {( \frac{2 π}{M} )}^{K} {\sum }_{n = 1}^{{N}_{1}} [ ( {n}^{K} - {( n - 1 )}^{K} ) \frac{cos ( ( n - \frac{1}{2} ) ( m {θ}_{M} - {\overline{θ}}_{M} ) ) - cos ( ( {N}_{1} + \frac{1}{2} ) ( m {θ}_{M} - {\overline{θ}}_{M} ) )}{2 sin \frac{1}{2} ( m {θ}_{M} - {\overline{θ}}_{M} )} ] \}$
$K is even \text{-} numbered , {h}_{m} = \frac{1}{M} \{ 2 {( \frac{2 π}{M} )}^{K} {\sum }_{n = 1}^{{N}_{1}} [ ( {n}^{K} - {( n - 1 )}^{K} ) \frac{sin ( ( {N}_{1} + \frac{1}{2} ) ( m {θ}_{M} - {\overline{θ}}_{M} ) ) - sin ( ( n - \frac{1}{2} ) ( m {θ}_{M} - {\overline{θ}}_{M} ) )}{2 sin \frac{1}{2} ( m {θ}_{M} - {\overline{θ}}_{M} )} ] \}$

The present invention also provides a digital differentiator where its frequency response coefficient hₘ is determined by the above tables. Then the type of the digital differentiator such as direct series-connected, or linear-phased digital differentiator may be determined. The setup of the digital differentiator is as such completed.

For example, for an order-N FIR filter having impulse response h[n], its output signal is y[n]=h[n]*x[n] where * is convolution operation. This output signal can also be expressed as

y[n]=h[n]*x[n]=Σₖ₌₀^{N}h[k]x[n−k] (eq 1)

(eq 1) means the output signal y[n] is the difference equation between the system impulse response h[n] and the input signal x[n]. FIG. 19 is an operational block diagram of a direct type FIR differentiator 1, which has an input terminal 11 and an output terminal 12. z⁻¹ is a delay element 13 that delays the input signal x[n] for an unit of time and outputs signal x[n−1]. The arrow lines indicate the propagation of signals. The h[n] above each arrow line is a multiplier 14 providing multiplication operation, and the outputs from the multipliers 14 are summed by adders 15 as the output signal y[n]. Under the given specification, the h[n] of various orders of the digital differentiator 1 is designed according to the previous tables. After h[n] is determined, the amplification factor of the multiplier 14 of the corresponding order is determined, thereby completing the design of the digital differentiator 1.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A method for designing a digital signal processing system, comprising
(1) selecting an order K of the digital signal processing system, where K is an integer,
(2) for odd-numbered K and when
$$\frac{K - 1}{2}$$
is an odd number, setting the frequency response function
$${H}^{( K )} ( w ) to \{ \begin{matrix}- {jw}^{K} , 0 \leq w < π \\ {jw}^{K} , - π \leq w \leq 0\end{matrix} ,$$
for odd-numbered K and when
$$\frac{K - 1}{2}$$
is an even number, setting H^{(K)}(w) to
$$\{ \begin{matrix}{jw}^{K} , 0 \leq w < π \\ - {jw}^{K} , - π \leq w \leq 0\end{matrix} ,$$
for even-numbered K and when
$$\frac{K}{2}$$
is an odd number, setting H^{(K)}(w) to −w^{K}, −π≤w<π; and for even-numbered K and when
$$\frac{K}{2}$$
is an even number, setting H^{K}(w) to
$$\{ \begin{matrix}{jw}^{K} , 0 \leq w < π \\ - {jw}^{K} , - π \leq w \leq 0\end{matrix} ,$$
where w is frequency, and H^{(K)}(w) is the value of Fourier transform (FT);
(3) based on the frequency response function, setting the frequency response coefficient hₘ, where m has a range 0≤m≤M−1 and M is the sampling point quantity; and
(4) based on the frequency response function, determining a type of the digital signal processing system.

2. The method according to claim 1, wherein, when the order K of the digital signal processing system is an odd number,
$$\frac{K - 1}{2}$$
is an odd number, and M is an even odd, the frequency response coefficient hₘ is
$$\frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{cos ( ( n - \frac{1}{2} ) ( m {θ}_{M} - {\overline{θ}}_{M} ) ) - cos ( \frac{M}{2} ( m {θ}_{M} - {\overline{θ}}_{M} ) )}{2 sin \frac{1}{2} ( m {θ}_{M} - {\overline{θ}}_{M} )} ] \} .$$

3. The method according to claim 1, wherein, when the order K of the digital signal processing system is an odd number,
$$\frac{K - 1}{2}$$
is an odd number, and M is an even number, the frequency response coefficient hₘ is
$$\frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{cos ( ( n - \frac{1}{2} ) ( m {θ}_{M} - {\overline{θ}}_{M} ) ) - cos ( ( \frac{M}{2} - \frac{1}{2} ) ( m {θ}_{M} - {\overline{θ}}_{M} ) )}{2 sin \frac{1}{2} ( m {θ}_{M} - {\overline{θ}}_{M} )} ] + {( \frac{2 π \cdot \frac{M}{2}}{M} )}^{K} {e}^{j \frac{2 m + M - 1}{2} π} \} .$$

4. The method according to claim 1, wherein, when the order K of the digital signal processing system is an odd number,
$$\frac{K - 1}{2}$$
is an even number, and M is an odd number, the frequency response coefficient hₘ is
$$\frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{cos ( ( n - \frac{1}{2} ) ( m {θ}_{M} - {\overline{θ}}_{M} ) ) - cos ( \frac{M}{2} ( m {θ}_{M} - {\overline{θ}}_{M} ) )}{2 sin \frac{1}{2} ( m {θ}_{M} - {\overline{θ}}_{M} )} ] \} .$$

5. The method according to claim 1, wherein, when the order K of the digital signal processing system is an odd number,
$$\frac{K - 1}{2}$$
is an even number, and M is an even number, the frequency response coefficient hₘ is
$$\frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{cos ( ( n - \frac{1}{2} ) ( m {θ}_{M} - {\overline{θ}}_{M} ) ) - cos ( ( \frac{M}{2} - \frac{1}{2} ) ( m {θ}_{M} - {\overline{θ}}_{M} ) )}{2 sin \frac{1}{2} ( m {θ}_{M} - {\overline{θ}}_{M} )} ] + {( \frac{2 π \cdot \frac{M}{2}}{M} )}^{K} {e}^{j \frac{2 m + M - 1}{2} π} \} .$$

6. The method according to claim 1, wherein, when the order K of the digital signal processing system is an even number,
$$\frac{K}{2}$$
is an odd number, and M is an odd number, the frequency response coefficient hₘ is
$$\frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{sin ( \frac{M}{2} ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} ] \} .$$

7. The method according to claim 1, wherein, when the order K of the digital signal processing system is an even number,
$$\frac{K}{2}$$
is an odd number, and M is an even number, the frequency response coefficient hₘ is
$$\frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{sin ( \frac{M}{2} - \frac{1}{2} ) ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} ] + {( \frac{2 π \cdot \frac{M}{2}}{M} )}^{K} {e}^{j ( m \frac{M}{2} {θ}_{M} + \frac{M}{2} {\overline{θ}}_{M} )} \} .$$

8. The method according to claim 1, wherein when the order K of the digital signal processing system is an even number,
$$\frac{K}{2}$$
is an even number, and M is an odd number, the frequency response coefficient hₘ is
$$\frac{1}{M} \{ 2 {( \frac{2 π}{M} )}^{K} {\sum }_{n = 1}^{\frac{M - 1}{2}} [ ( {n}^{K} - {( n - 1 )}^{K} ) \frac{sin ( \frac{M}{2} - ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} ] \} .$$

9. The method according to claim 1, wherein, when the order K of the digital signal processing system is an even number,
$$\frac{K}{2}$$
is an even number, and M is an even number, the frequency response coefficient hₘ is
$$\frac{1}{M} \{ 2 {( \frac{2 π}{M} )}^{K} {\sum }_{n = 1}^{\frac{M}{2} - 1} [ ( {n}^{K} - {( n - 1 )}^{K} ) \frac{sin ( \frac{M}{2} - \frac{1}{2} ) ( m {θ}_{M} - {\overline{θ}}_{M} ) - sin ( n - \frac{1}{2} ) ( m {θ}_{M} - {\overline{θ}}_{M} )}{2 sin \frac{1}{2} ( m {θ}_{M} - {\overline{θ}}_{M} )} ] + {( \frac{2 π \cdot \frac{M}{2}}{M} )}^{K} {e}^{j ( m \frac{M}{2} {θ}_{M} + \frac{M}{2} {\overline{θ}}_{M} )} \} .$$

10. A digital signal processing system having an order K where K is an integer, comprising
a frequency response function H^{(K)}(w), which is a Fourier transform (FT) function of order K at frequency w and a frequency response coefficient hₘ corresponding to the frequency response function, where 0≤m≤M−1, M is the sampling point quantity, and H^{(K)}(w) is one of
$$\{ \begin{matrix}- {jw}^{K} , 0 \leq w < π \\ {jw}^{K} , - π \leq w \leq 0\end{matrix} ,$$
$$\{ \begin{matrix}{jw}^{K} , 0 \leq w < π \\ - {jw}^{K} , - π \leq w \leq 0\end{matrix} , - {w}^{K} , - π \leq w < π , and \\ \{ \begin{matrix}{jw}^{K} , 0 \leq w < π \\ - {jw}^{K} , - π \leq w \leq 0\end{matrix} ,$$
or combination thereof.

11. The digital signal processing system according to claim 10, further comprising at least a multiplier between an input terminal and an output terminal of the digital signal processing system, wherein each multiplier's amplification factor matches a corresponding frequency response coefficient hₘ.

12. The digital signal processing system according to claim 10, wherein the digital signal processing system is one of a direct, series-connected, and linear-phased system or a combination thereof.

13. The digital signal processing system according to claim 11, wherein the digital signal processing system is one of a direct, series-connected, and linear-phased system or a combination thereof.
